(19) United States
(12) Patent Application Publication
(10) Pub. No.: US 2025/0367046 A1
(43) Pub. Date: Dec. 4, 2025

(54) PERSONAL MOBILITY/UTILITY SYSTEM

(71) Applicant: GM GLOBAL TECHNOLOGY OPERATIONS LLC., Detroit, MI (US)

(72) Inventors: Paul W. Alexander, Ypsilanti, MI (US); David W. Heyne, Royal Oak, MI (US)

(73) Assignee: GM GLOBAL TECHNOLOGY OPERATIONS LLC, Detroit, MI (US)

(21) Appl. No.: 18/679,777

(22) Filed: May 31, 2024

(51) Int. Cl. A61G 5/04; A61H 3/04; B60L 50/60; B62D 11/04

(52) U.S. Cl. CPC A61G 5/047; A61H 3/04; B60L 50/66; B62D 11/04; A61H 2003/043; A61H 2201/0107; A61H 2201/1215; A61H 2201/1635

(57) ABSTRACT

A personal mobility/utility system includes a housing, first and second dual-shaft electric motors within the housing with each having respective inboard and outboard shafts, first and second traction wheels rotatably attached to the first and second output shafts via first and second wheel clutches, first and second module gears rotatably attached to the first and second inboard shafts via respective first and second module clutches, first and second vertical apertures having respective top openings at a top of the housing and respective bottom openings adjacent the first and second module gears, a sensor array, and a controller for controlling the electric motors and clutches to provide propulsion, steering and braking of the system, extension, retraction and/or rotation of a module inserted into one or both of the vertical apertures, and maintaining the system in an upright position.

This disclosure relates generally to personal mobility/utility systems.

Some individuals may find it difficult to walk along floors, sidewalks, the ground and other support surfaces due to age, disability or other conditions. This difficulty may also include ascending and descending ramps, crossing thresholds (such as may be found when traversing from one room to another or when entering and exiting an elevator), as well as boarding and exiting vehicles such as cars, trucks, busses, trains, ships, airplanes and the like.

Assistive devices such as traditional walkers, canes and wheelchairs may sometimes help with these difficulties, but the use of such devices may also present other challenges.

### SUMMARY

According to one embodiment, a personal mobility/utility system includes: (i) a generally elongate housing having a center, a longitudinal axis passing through the center, and a midline passing through the center and running perpendicular to the longitudinal axis and defining opposed first and second ends of the housing; (ii) first and second dual-shaft electric motors disposed within the housing at the first and second ends, respectively, with each having a respective inboard shaft extending toward the midline and a respective outboard shaft extending opposite the respective inboard shaft, wherein the respective inboard and outboard shafts are aligned parallel or colinear with the longitudinal axis; (iii) first and second traction wheels rotatably attached to the first and second output shafts, respectively, via respective first and second wheel clutches and extending outside the housing at the first and second ends, respectively; (iv) first and second module gears rotatably attached to the first and second inboard shafts, respectively, via respective first and second module clutches; (v) first and second generally tubular vertical apertures formed in the housing and having respective first and second top openings defined at a top of the housing and respective first and second bottom openings opposite the respective first and second top openings and situated adjacent the first and second module gears, respectively; (vi) a sensor array disposed on or within the housing for detecting inputs including one or more of motive inputs from a user, command inputs from the user, environmental inputs from a surrounding environment and attitude inputs from an attitude sensor, and for providing one or more sensor signals indicative of the detected inputs; and (vii) a controller disposed within the housing for receiving the one or more sensor signals and for controlling the first and second dual-shaft electric motors, the first and second wheel clutches and the first and second module clutches so as to provide propulsion, steering and braking of the personal mobility/utility system by selective engagement of the first and second dual-shaft electric motors and the first and second wheel clutches, provide one or more of extension, retraction and rotation of a module by selective engagement of the first and second dual-shaft electric motors and the first and second module clutches when the module is inserted into one or both of the first and second vertical apertures and is engaged with one or both of the first and second module gears, and maintain the personal mobility/utility system in an upright position.

The personal mobility/utility system may further include at least one primary battery disposed within the housing and configured for providing electrical power to the first and second dual-shaft electric motors, the sensor array and the controller.

The motive inputs may include one or more of a push exerted upon the personal mobility/utility system by the user, a pull exerted upon the personal mobility/utility system by the user and a turn exerted upon the personal mobility/utility system by the user.

The command inputs may include one or more of a voice command, a button press, a button release, a joystick manipulation, a joystick release, a knob turn, a toggle manipulation, a selector manipulation, a slider manipulation, a caliper squeeze and a caliper release.

The environmental inputs may include one or more of a proximity input indicative of a bearing, a proximity and/or an external location of an object, an obstacle or a geofence border within the surrounding environment, a geo-spatial positioning signal for determining a current location of the personal mobility/utility system, a warning from a warning device, and a navigation command or instruction from a navigation device.

The attitude inputs may include one or both of a forward degree of pitch of the personal mobility/utility system and a rearward degree of pitch of the personal mobility/utility system.

The controller may be further configured for one or more of: determining a current location of the personal mobility/utility system; determining one or more of a bearing, a proximity and an external location of an object, an obstacle or a geofence border within the surrounding environment; causing the personal mobility/utility system to identify, avoid, approach and/or interact with the object, the obstacle or the geofence border; and causing the personal mobility/utility system to follow and/or deviate from a predetermined path.

The personal mobility/utility system may further include a walker module having an upright portion with a top end and a bottom end with the bottom end being configured for insertion into the first and second vertical apertures, and handlebars attached to the top end of the upright portion.

The personal mobility/utility system may further include an outrigger module having a vertical portion with an upper end and a lower end with the lower end being configured for insertion into one of the first and second vertical apertures, an arm portion with a leading end attached to the upper end of the vertical portion and a trailing end opposite the leading end, and a caster attached to the trailing end of the arm portion.

The upper end of the vertical portion may have a vertically oriented socket formed therein, and the personal mobility/utility system may further include a walker module having an upright portion with a top end and a bottom end with the bottom end being configured for insertion into the socket, and handlebars attached to the top end of the upright portion. Alternatively, the personal mobility/utility system may further include a cargo module having an upright portion with a top end and a bottom end with the bottom end being configured for insertion into the socket, a basket with a front side, a back side, a top side and a bottom side with at least one of the front and bottom sides being attached to the top end of the upright portion, and handlebars attached to at least one of the top and back sides of the basket. As another alternative, the personal mobility/utility system may include a seat module having an upright portion with a top end and a bottom end with the bottom end being configured for insertion into the socket, and a seat attached to the top end of the upright portion.

Each of the first and second traction wheels may include a respective externally toothed portion sandwiched between a respective inner tire portion and a respective outer tire portion, and the personal mobility/utility system may further include a wheel module having a rim, a tire attached to an outer circumferential surface of the rim, and a handrim attached to an outer face of the rim. The rim may have an internally toothed portion sandwiched between a first inner circumferential surface and a second inner circumferential surface, an outer wall extending radially inward from the outer face and an inner wall extending radially inward from an inner face of the rim. One of the first and second traction wheels may be disposed in contact with the wheel module such that the respective externally toothed portion engages with the internally toothed portion, the respective inner tire portion is disposed in contact with the first inner circumferential surface between the internally toothed portion and the inner wall, and the respective outer tire portion is disposed in contact with the second inner circumferential surface between the internally toothed portion and the outer wall. Additionally, the upper end of the vertical portion may have a vertically oriented socket formed therein, and the personal mobility/utility system may further include a seat module having an upright portion with a top end and a bottom end with the bottom end being configured for insertion into the socket, and a seat attached to the top end of the upright portion.

Alternatively, each of the first and second traction wheels may include a respective tire portion and a respective externally toothed portion on a respective inner side and/or on a respective outer side of the respective traction wheel. In this arrangement, the personal mobility/utility system may include a wheel module having a rim, a tire attached to an outer circumferential surface of the rim, and a handrim attached to an outer face of the rim. The rim may have an internally toothed portion adjacent and inside an inner wall extending radially inward from an inner face of the rim and/or adjacent and inside an outer wall extending radially inward from the outer face of the rim, and an inner circumferential surface between the inner wall and the outer wall. One of the first and second traction wheels may be disposed in contact with the wheel module such that the respective externally toothed portion engages with the internally toothed portion and the respective tire portion is disposed in contact with the inner circumferential surface between the inner wall and the outer wall.

The personal mobility/utility system may be separable into a first half which includes the first dual-shaft electric motor, the first traction wheel, the first module gear and the first generally tubular vertical aperture, and a second half which includes the second dual-shaft electric motor, the second traction wheel, the second module gear and the second generally tubular vertical aperture, and the personal mobility/utility system may further include one or more telescoping rails each having a respective first rail end captured within the first half and a respective second rail end captured within the second half, wherein each of the one or more telescoping rails is configured for extending so as to dispose the first and second halves spaced apart from each other and for retracting so as to dispose the first and second halves in contact with each other. Additionally, the personal mobility/utility system may further include an auxiliary battery configured for installation between the first and second halves when the first and second halves are spaced apart from each other. The auxiliary battery may include a radial slot therein defined by opposed slot walls, such that when the auxiliary battery is installed between the first and second halves, the one or more telescoping rails fit within the radial slot. At least one of the opposed slot walls may include a cooling inlet and at least one of the first and second halves may include a cooling port for supplying cooled air to the cooling inlet when the auxiliary battery is installed between the first and second halves.

The personal mobility/utility system may also include an auxiliary battery port externally accessible through the housing and directly or indirectly electrically connected with one or more of the at least one primary battery and the first and second dual-shaft electric motors, and an auxiliary battery configured for electrical connection with the auxiliary battery port.

According to another embodiment, a personal mobility/utility system includes: (i) a generally elongate housing having a center, a longitudinal axis passing through the center, and a midline passing through the center and running perpendicular to the longitudinal axis and defining opposed first and second ends of the housing; (ii) first and second dual-shaft electric motors disposed within the housing at the first and second ends, respectively, with each having a respective inboard shaft extending toward the midline and a respective outboard shaft extending opposite the respective inboard shaft, wherein the respective inboard and outboard shafts are aligned parallel or colinear with the longitudinal axis; (iii) first and second traction wheels rotatably attached to the first and second output shafts, respectively, via respective first and second wheel clutches and extending outside the housing at the first and second ends, respectively; (iv) first and second module gears rotatably attached to the first and second inboard shafts, respectively, via respective first and second module clutches; (v) first and second generally tubular vertical apertures formed in the housing and having respective first and second top openings defined at a top of the housing and respective first and second bottom openings opposite the respective first and second top openings and situated adjacent the first and second module gears, respectively; (vi) a sensor array disposed on or within the housing for detecting inputs including one or more of motive inputs from a user, command inputs from the user, environmental inputs from a surrounding environment and attitude inputs from an attitude sensor, and for providing one or more sensor signals indicative of the detected inputs; (vii) a controller disposed within the housing for receiving the one or more sensor signals and for controlling the first and second dual-shaft electric motors, the first and second wheel clutches and the first and second module clutches so as to provide propulsion, steering and braking of the personal mobility/utility system by selective engagement of the first and second dual-shaft electric motors and the first and second wheel clutches, provide one or more of extension, retraction and rotation of a module by selective engagement of the first and second dual-shaft electric motors and the first and second module clutches when the module is inserted into one or both of the first and second vertical apertures and is engaged with one or both of the first and second module gears, and maintain the personal mobility/utility system in an upright position; (viii) at least one primary battery disposed within the housing and configured for providing electrical power to the first and second dual-shaft electric motors, the sensor array and the controller; (ix) a first outrigger module having a first vertical portion with a first upper end and a first lower end with the first lower end being configured for insertion into the first vertical aperture, a first arm portion with a first leading end attached to the first upper end of the first vertical portion and a first trailing end opposite the first leading end, and a first caster attached to the first trailing end of the first arm portion; and (x) a second outrigger module having a second vertical portion with a second upper end and a second lower end with the second lower end being configured for insertion into the second vertical aperture, a second arm portion with a second leading end attached to the second upper end of the second vertical portion and a second trailing end opposite the second leading end, and a second caster attached to the second trailing end of the second arm portion.

According to yet another embodiment, a method for maneuvering a personal mobility/utility system is provided. The personal mobility/utility system has a center, a longitudinal axis passing through the center and defining a first side and a second side, a midline passing through the center and running perpendicular to the longitudinal axis, a first outrigger module attached to a top of the personal mobility/utility system at a first pivot point, and a second outrigger module attached to the top at a second pivot point, wherein the personal mobility/utility system is configured to carry a payload having a payload center of gravity. The method includes: (i) positioning the personal mobility/utility system in a first position, wherein the payload center of gravity is located on the first side and the first and second outrigger modules are disposed on the first side; (ii) rotating the first outrigger module about the first pivot point and toward the midline; (iii) rotating the second outrigger module about the second pivot point and onto the second side; (iv) repositioning the payload so as to move the payload center or gravity from the first side to the second side; and (v) rotating the first outrigger module about the first pivot point from the first side to the second side.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIGS. 1A-B are perspective views of a personal mobility/utility system with two outrigger modules having lifter elements, where the lifter elements are lowered in FIG. 1A and raised in FIG. 1B.

FIG. 2 is a top view of the personal mobility/utility system without any outrigger modules.

FIG. 3 is the same view as FIG. 2 but with the housing removed.

FIG. 4 is a perspective view of a first half of the personal mobility/utility system.

FIG. 5 is a close-up schematic cross-sectional view of the housing, first and second vertical apertures and first and second module gears.

FIG. 6 is an exploded schematic view of the personal mobility/utility system with the housing removed.

FIG. 7 shows a block diagram of various inputs which may be detected by the personal mobility/utility system.

FIGS. 8A-B are perspective schematic views of the personal mobility/utility system in retracted and extended positions, respectively.

FIGS. 9A-C are successive top schematic views of the personal mobility/utility system in the retracted position, in a middle position between the retracted and extended positions, and in the extended position, respectively.

FIG. 10A is a perspective schematic view of the personal mobility/utility system in the extended position along with an auxiliary battery, and FIG. 10B is the same view as FIG. 10A but with the auxiliary battery installed and the personal mobility/utility system in a collapsed position.

FIG. 11A is a top view of the personal mobility/utility system having an auxiliary battery port, and FIG. 11B is an assembled view of FIG. 11A in which the personal mobility/utility system is electrically connected with an auxiliary battery via the auxiliary battery port.

FIG. 12 is a perspective view of the personal mobility/utility system with a walker module attached.

FIGS. 13A-C show side views of the personal mobility/utility system and a walker module in a tipped-forward position, and upright position and a tipped-backward position, respectively.

FIG. 14 is a schematic side view of an outrigger module.

FIG. 15 is a partially cross-sectional schematic side view of an alternative outrigger module.

FIGS. 16-17 are schematic side views of first and second outrigger modules, respectively.

FIGS. 18-19 are perspective and side views, respectively, of the personal mobility/utility system having two outrigger modules and a walker module.

FIGS. 20-21 are side views of the personal mobility/utility system shown in FIG. 19, with the addition of a jump seat and a platform, respectively.

FIG. 22 is a side view of the personal mobility/utility system including a cargo module.

FIG. 23 is a side view of the personal mobility/utility system shown in FIG. 22, but also having an inflatable bladder for dumping.

FIG. 24 is a side view of the personal mobility/utility system including a seat module.

FIGS. 25A is a side view and FIG. 25B is a cross-sectional front view of a first embodiment of a wheel module.

FIG. 26 is a close-up view of part of the wheel module shown in FIG. 25B along with a traction wheel.

FIGS. 27-28 are partially cross-sectional close-up front views of two different versions of a second embodiment of a wheel module.

FIGS. 29-30 are schematic side views of a traction wheel inside a wheel module before engagement and after engagement, respectively, between the traction wheel and the wheel module.

FIG. 31 is a flowchart for a method of maneuvering a personal mobility/utility system having first and second outrigger modules.

FIGS. 32A-H are a sequence of positions for the steps shown in the flowchart of FIG. 31.

FIGS. 33A-C are a sequence of positions of an outrigger for an alternative method of maneuvering a personal mobility/utility system.

### DETAILED DESCRIPTION

Referring now to the drawings, wherein like numerals indicate like parts in the several views, a personal mobility/utility system 20 and a method 200 for maneuvering a personal mobility/utility system 20 are shown and described herein.

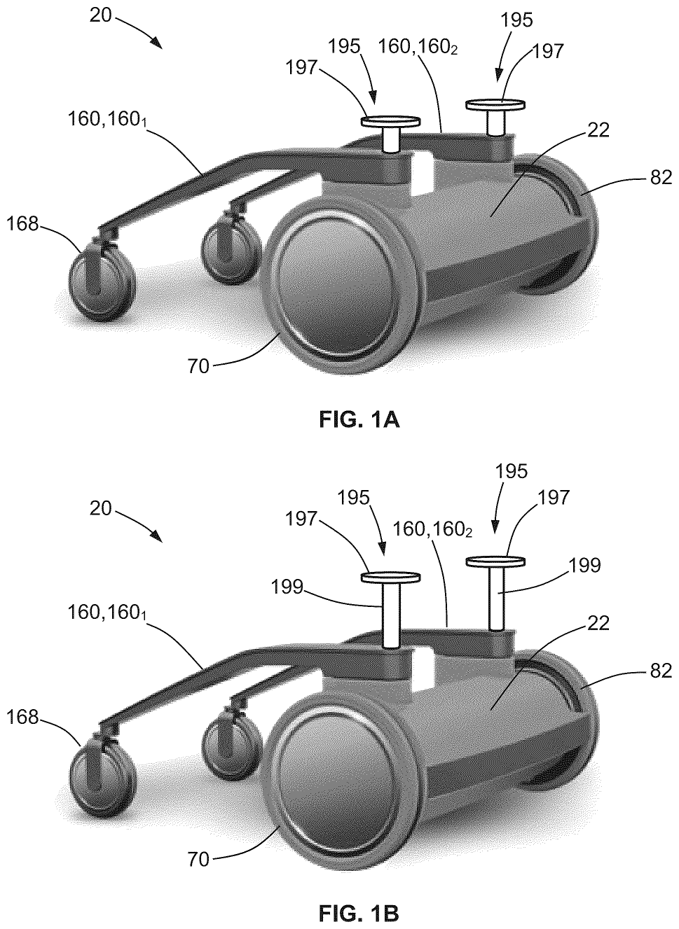

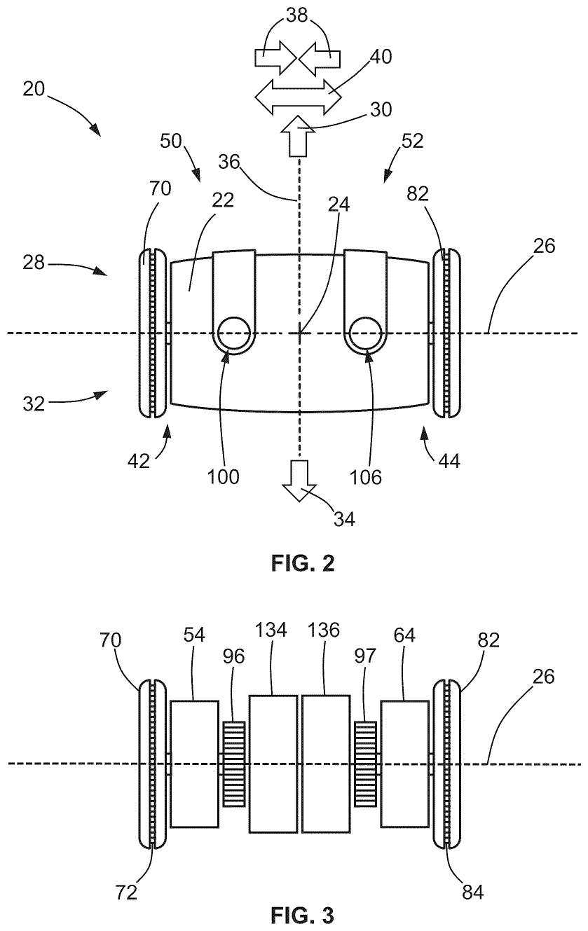

FIGS. 1A-B show perspective views of the personal mobility/utility system 20 with two outrigger modules 160 having lifter elements 195, where the lifter elements 195 are lowered in FIG. 1A and raised in FIG. 1B. FIG. 2 shows a top view of the personal mobility/utility system 20 without any outrigger modules 160, and FIG. 3 shows the same view as FIG. 2 but with the housing 22 removed.

The personal mobility/utility system 20 includes a generally elongate housing 22 having a center 24 and a longitudinal axis 26 passing through the center 24. A midline 36 also passes through the center 24 and runs perpendicular to the longitudinal axis 26, and additionally a vertical axis 27 also passes through the center 24. Taken together, the longitudinal axis 26 and the midline 36 may be viewed as dividing the housing 22 and the personal mobility/utility system 20 into four parts or quadrants. The longitudinal axis 26 may be seen as dividing the housing 22 and the personal mobility/utility system 20 into a first side 28 and a second side 32, with the midline 36 pointing along a first direction 30 on the first side 28 and along a second direction 34 on the second side 32. The midline 36 may be seen as dividing the housing 22 and the personal mobility/utility system 20 into a first half 50 and a second half 52, with an inboard direction 38 being defined as pointing toward the midline 36 and an outboard direction 40 being defined as pointing away from the midline 36 and in a direction opposite the inboard direction 38. The first half 50, the housing 22 and the personal mobility/utility system 20 have a first end 42 that is distal from the midline 36, while the second half 52, the housing 22 and the personal mobility/utility system 20 have a second end 44 that is distal from the midline 36 and opposite the first end 42.

First and second dual-shaft electric motors 54, 64 are disposed within the housing 22 at the first and second ends 42, 44, respectively. The first dual-shaft electric motor 54 has a first inboard shaft 56 extending toward the midline 36 (i.e., in an inboard direction 38), and a first outboard shaft 60 extending in the opposite direction as the first inboard shaft 56 (i.e., in an outboard direction 40). The second dual-shaft electric motor 64 has a second inboard shaft 66 extending toward the midline 36, and a second outboard shaft 68 extending in the opposite direction as the second inboard shaft 66. The inboard and outboard shafts 56, 60, 66, 68 are aligned and oriented so as to be parallel or colinear with each other and with the longitudinal axis 26 of the housing 22.

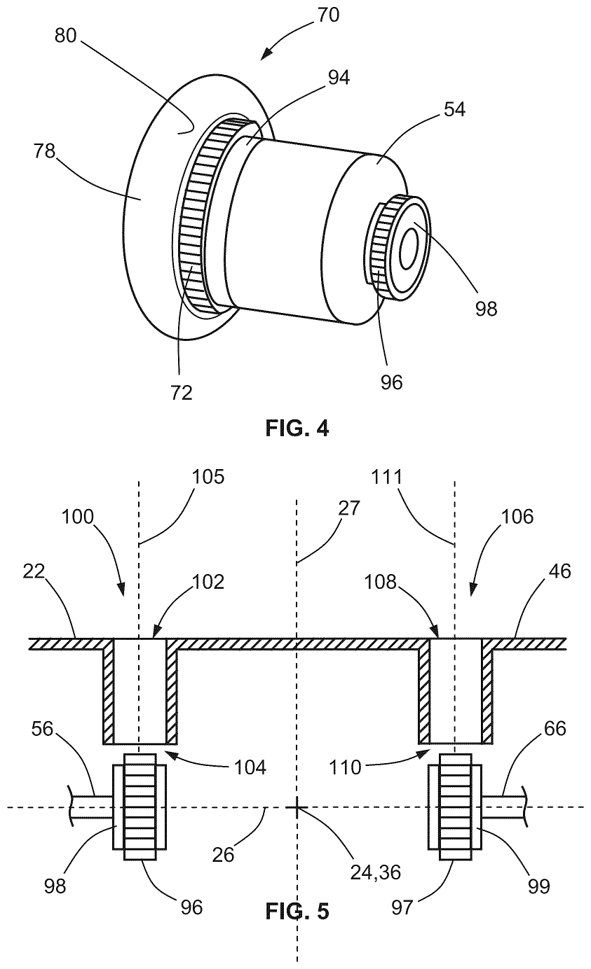

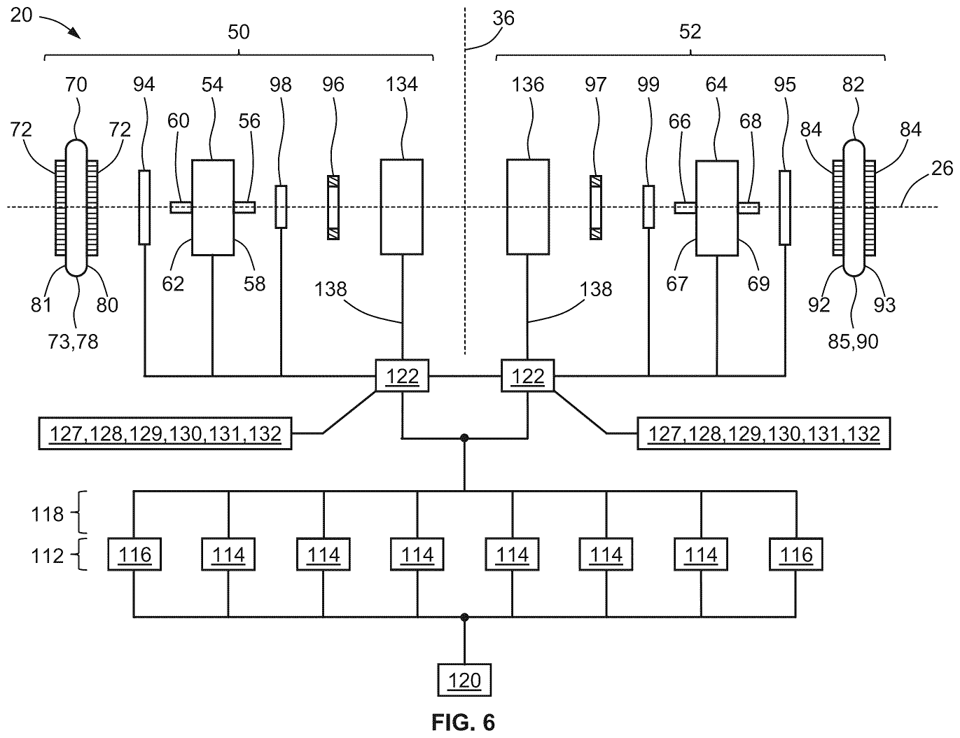

FIG. 4 shows a perspective view of a first half 50 of the personal mobility/utility system 20, and FIG. 5 shows a close-up schematic cross-sectional view of the housing 22, first and second vertical apertures 100, 106 and first and second module gears 96, 97. Additionally, FIG. 6 shows an exploded schematic view of the personal mobility/utility system 20 with the housing 22 removed. As shown in the drawings, first and second traction wheels 70, 82 are rotatably attached to the first and second output shafts 60, 68, respectively, via respective first and second wheel clutches 94, 95. Some or all of the first traction wheel 70 extends outside the housing 22 at the first end 42, and some or all of the second traction wheel 82 extends outside the housing 22 at the second end 44, such that both traction wheels 70, 82 are able to make contact with the ground or other generally flat supporting surfaces (e.g., pavement, sidewalks, floors, wheelchair ramps, etc.) when the personal mobility/utility system 20 is situated on such surfaces. The first traction wheel 70 has a first inboard side 58 and a first outboard side 62, and the second traction wheel 82 has a second inboard side 67 and a second outboard side 69. Additionally, first and second module gears 96, 97 are rotatably attached to the first and second inboard shafts 56, 66, respectively, via respective first and second module clutches 98, 99.

First and second generally tubular vertical apertures 100, 106 or “tubes” are formed in the housing 22. Note that the tubular cross-section of each vertical aperture 100, 106 may be circular, rectangular, hexagonal or any other suitable shape, with the first vertical aperture 100 having a central vertical axis defining a first pivot point 105 (i.e., a first pivot axis), and the second vertical aperture 106 having a central vertical axis defining a second pivot point 11 (i.e., a second pivot axis). The first and second vertical apertures 100, 106 have respective first and second top openings 102, 108 defined at a top 46 of the housing 22 and respective first and second bottom openings 104, 110 within the housing 22 opposite the respective first and second top openings 102, 108. The first bottom opening 104 is situated adjacent the first module gear 96, and the second bottom opening 110 is situated adjacent the second module gear 97. Note that each of the first and second module gears 96, 97 may include a respective gear train involving multiple gears, including helical gears, bevel gears, worm gears, hypoid gears, rack-and-pinion gears, miter gears, etc. Additionally, a controller 122 (described in more detail below) may controllably and selectably engage the various gears within the respective gear trains of the first and second module gears 96, 97 so as to selectably provide one or more of extension 130, retraction 131 and rotation 132 to modules 152 that are inserted into the vertical apertures 100, 106 and that engage with the first and second module gears 96, 97, as described in more detail below.

In this arrangement, one or both of the first and second wheel clutches 94, 95 may be engaged such that one or both of the first and second outboard shafts 60, 68 is coupled with one or both of the first and second traction wheels 70, 82; this may be done in order to selectably move the personal mobility/utility system 20 “forward” and “backward” as desired, and to turn the personal mobility/utility system 20 “leftward” and “rightward” as desired. (Note that the foregoing directional terms are presented in quotation marks as these directions might not always be absolute, but may be relative and so may change as the personal mobility/utility system 20 moves about.)

Similarly, in this arrangement, one or both of the first and second module clutches 98, 99 may be engaged such that one or both of the first and second inboard shafts 56, 66 is coupled with one or both of the first and second module gears 96, 97; for example, this may be done when one or both of a first outrigger module 1601 and a second outrigger module 1602 are inserted into the first and second vertical apertures 100, 106, in order to selectably rotate one or both of the first and second module gears 96, 97, which in turn may interface with one or more modules 152 so as to rotate the one or more modules 152 about the first and second pivot points 105, 111, and/or to selectably raise and lower the one or more modules 152 or portions thereof that are carried by the one or more modules 152. For example, an outrigger module 160 may be inserted into each of the first and second respective first and second vertical apertures 100, 106 so as to also engage with the first and second module gears 96, 97; then, when the first and second module gears 96, 97 are selectably rotated (e.g., one at a time, or both at a time), this may cause one or both of the outrigger modules 160 (or portions thereof, such as lifter elements 195, etc.) to be rotated about the respective first and second pivot points 105, 111 and/or to be selectably raised and lowered. (Note that as used herein, reference numeral 160 may refer to either or both of the first and second outrigger modules 160₁, 160₂.)

A sensor array 112 is disposed on or within the housing 22 for detecting various inputs 120. These inputs 120 may include motive inputs 120_{M} from a user 10, command inputs 120_{C} from the user 10, environmental inputs 120_{E} from a surrounding environment 12 and attitude inputs 120_{A} from an attitude sensor 116. The sensor array 112 may include the attitude sensor 116 and a network or collection of various other types of sensors 114, such as proximity sensors, vision sensors, audio sensors, pressure sensors, and the like, which may utilize LIDAR (i.e., light detection and ranging), lasers, ultrasonics, photocells, mercury levels, etc. The sensor array 112 provides one or more sensor signals 118 that are indicative or representative of the various detected inputs 120.

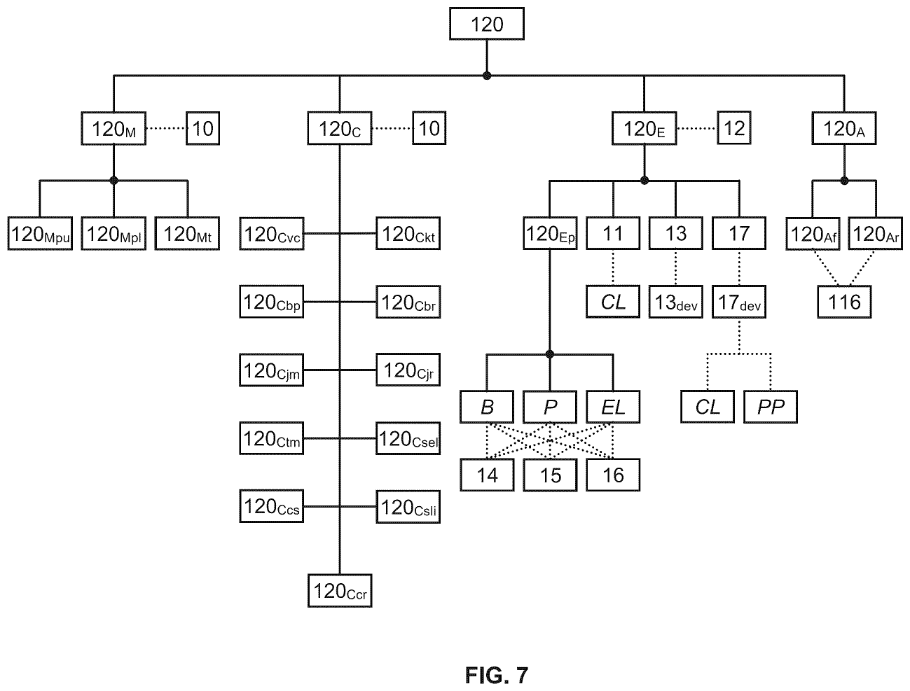

FIG. 7 shows a block diagram of the various inputs 120 introduced above. For example, the motive inputs 120_{M} may include one or more of a push 120_{Mpu} exerted upon the personal mobility/utility system 20 by the user 10, a pull 120_{Mpl} exerted upon the personal mobility/utility system 20 by the user 10 and a turn 120_{Mt} exerted upon the personal mobility/utility system 20 by the user 10. Assuming that the personal mobility/utility system 20 is oriented and rigged such that the first direction 30 is a “forward” direction and the second direction 34 is a “backward” direction, then a push 120_{Mpu} may be detected by a sensor 114 as a physical push by the user 10 generally in the forward/first direction 30, and a pull 120_{Mpl} may be detected by a sensor 114 as a physical pull by the user 10 in the rearward/second direction 34. A push 120_{Mpu} or a pull 120_{Mpl} may be exerted by the user 10 in a generally straight line, or it may involve a turn 120_{Mt} as well, in which the user 10 exerts effort to cause the personal mobility/utility system 20 to move in a generally curved line, which also may be detected by a sensor 114. Alternatively, a turn 120_{Mt} can also be a rotation in-place (i.e., about the vertical axis 27 of the personal mobility/utility system 20), without any significant push forward or pull backward, and this motion may also be detected by one or more sensors 114.

The command inputs 120_{C} may include one or more of a voice command 120_{Cvc}, a button press 120_{Cbp}, a button release 120_{Cbr}, a joystick manipulation 120_{Cjm}, a joystick release 120_{Cjr}, a knob turn 120_{Ckt}, a toggle manipulation 120_{Ctm}, a selector manipulation 120_{Csel}, a slider manipulation 120_{Csli}, a caliper squeeze 120_{Ccs} and a caliper release 120_{Ccr}, each of which may be implemented by the user 10. Sensors within the sensor array 112 for detecting these command inputs 120_{C} may include audio sensors (for detecting voice commands 120_{Cvc}), pressure sensors underneath keyboard buttons or other buttons (for detecting a button press 120_{Cbp} and a button release 120_{Cbr}), etc.

The environmental inputs 120_{E} may include one or more of: (i) a proximity input 120_{Ep} indicative of a bearing B (i.e., a directional heading), a proximity P (i.e., a distance away) and/or an external location EL (e.g., x-y-z coordinates in either an absolute reference frame or in a relative reference frame where the personal mobility/utility system 20 is the origin) of an object 14, an obstacle 15 or a geofence border 16 within the surrounding environment 12; (ii) a geo-spatial positioning signal 11 (e.g., from a GPS satellite or transponder) for determining a current location CL of the personal mobility/utility system 20; (iii) a warning 13 from a warning device 13_{dev}; and (iv) a navigation command or instruction 17 from a navigation device 17_{dev}. For example, the warning device 13_{dev} may be a beacon, a transponder, a klaxon, etc., and the navigation device 17_{dev} may be a wireless device which transmits commands or information relating to the current location CL of the personal mobility/utility system 20 and/or to a predetermined path PP which the personal mobility/utility system 20 should follow, all of which may be received by the sensor array 112.

The attitude inputs 120_{A} may include one or both of a forward degree of pitch 120_{Af} of the personal mobility/utility system 20 (i.e., about the longitudinal axis 26), and a rearward degree of pitch 120_{Ar} of the personal mobility/utility system 20. For example, if the personal mobility/utility system 20 is in use and it tips forward as illustrated in FIG. 13A, or if it tips backward as illustrated in FIG. 13C, then the attitude sensor 116 may sense the forward or rearward degree of pitch 120_{Af}, 120_{Ar} and produce a corresponding sensor signal 118. This signal 118 may then be received or detected by a controller 122 (discussed in more detail below), which may then cause the first and second dual-shaft electric motors 54, 64 to engage so as to make the personal mobility/utility system 20 to assume the default or upright position 48 illustrated in FIG. 13B.

A controller 122 is disposed within the housing 22 for receiving the one or more sensor signals 118 and for controlling the first and second dual-shaft electric motors 54, 64, the first and second wheel clutches 94, 95 and the first and second module clutches 98, 99 so as to perform the following: (i) provide propulsion 127, steering 128 and braking 129 of the personal mobility/utility system 20 by selective engagement of the first and second dual-shaft electric motors 54, 64 and the first and second wheel clutches 94, 95; (ii) provide one or more of extension 130, retraction 131 and rotation 132 of a module 152 (or elements of the module 152) by selective engagement of the first and second dual-shaft electric motors 54, 64 and the first and second module clutches 98, 99 when the module 152 is inserted into one or both of the first and second vertical apertures 100, 106 and is engaged with one or both of the first and second module gears 96, 97; and (iii) maintain the personal mobility/utility system 20 in an upright position 48.

In some configurations, either the first and second wheel clutches 94, 95 may be engaged, thus connecting the first and second outboard shafts 60, 68 with the first and second traction wheels 70, 82, or the first and second module clutches 98, 99 may be engaged, thus connecting the first and second inboard shafts 56, 66 with the first and second module gears 96, 97, but the first and second wheel clutches 94, 95 would not be engaged simultaneously with the first and second module clutches 98, 99. That is, either propulsion 127, steering 128 and/or braking 129 may be provided, or extension 130, retraction 131 and/or rotation 132 may be provided. However, in other configurations, both the first and second wheel clutches 94, 95 and the first and second module clutches 98, 99 may be engaged simultaneously, such that propulsion 127, steering 128 and braking 129 may be provided simultaneously with extension 130, retraction 131 and rotation 132.

The personal mobility/utility system 20 may further include at least one primary battery 134, 136 disposed within the housing 22 and configured for providing electrical power 138 to the first and second dual-shaft electric motors 54, 64, the sensor array 112 and the controller 122. For example, a first primary battery 134 may be provided within the first half 50 of the personal mobility/utility system 20, and a second primary battery 136 may be provided within the second half 52 of the personal mobility/utility system 20. Alternatively, a single primary battery may be provided within the personal mobility/utility system 20.

The controller 122 may be further configured for one or more of the following: (i) determining a current location CL of the personal mobility/utility system 20; (ii) determining one or more of a bearing B, a proximity P and an external location EL of an object 14, an obstacle 15 or a geofence border 16 within the surrounding environment 12; (iii) causing the personal mobility/utility system 20 to identify, avoid, approach and/or interact with the object 14, the obstacle 15 or the geofence border 16; and (iv) causing the personal mobility/utility system 20 to follow and/or deviate from a predetermined path PP. The predetermined path PP may be input into or accessible by the controller 122. For example, the predetermined path PP may be broadcasted or sent via telemetry as a navigation command or instruction 17 by a navigation device 17_{dev}, which may then be received by a sensor 114 in the sensor array 112 (e.g., by a WiFi, Bluetooth or radio receiver) and sent to the controller 122. Then, the controller 122 may selectably and differentially control the first and second dual-shaft electric motors 54, 64 and the first and second wheel clutches 94, 95 so that the personal mobility/utility system 20 is provided with propulsion 127, steering 128 and braking 129 so as to keep the personal mobility/utility system 20 on the predetermined path PP.

As noted above, the personal mobility/utility system 20 may be separable into a first half 50 and a second half 52. As shown in the drawings, the first half 50 includes the first dual-shaft electric motor 54, the first traction wheel 70, the first module gear 96 and the first generally tubular vertical aperture 100, and the second half 52 includes the second dual-shaft electric motor 64, the second traction wheel 82, the second module gear 97 and the second generally tubular vertical aperture 106. The controller 122 may be divided or duplicated such that each of the first and second halves 50, 52 has its own dedicated controller 122 to control that respective half, but with the two separate controllers 122 communicating and cooperating with each other, or the personal mobility/utility system 20 may have a single controller 122 which controls both halves 50, 52.

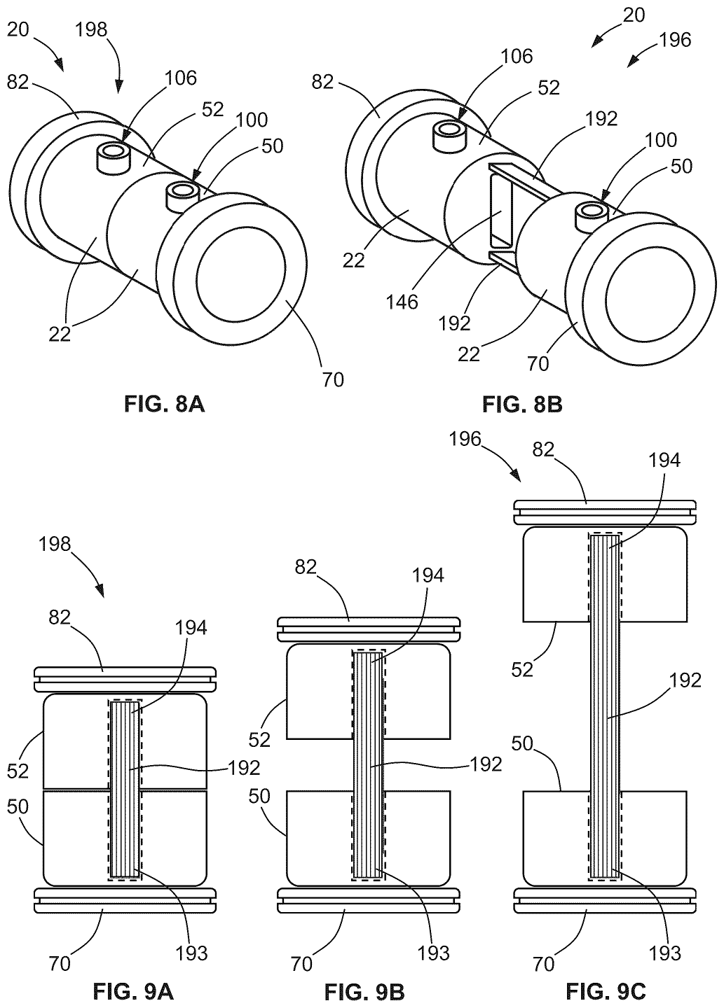

As illustrated in FIGS. 8A-B and 9A-C, the personal mobility/utility system 20 may further include one or more telescoping rails 192, with each having a respective first rail end 193 captured within the first half 50 and a respective second rail end 194 captured within the second half 52. Each of the one or more telescoping rails 192 is configured for extending so as to dispose the first and second halves 50, 52 spaced apart from each other in an extended position 196 (see FIGS. 8B and 9C), and for retracting so as to dispose the first and second halves 50, 52 in contact with each other in a retracted position 198 (see FIGS. 8A and 9A).

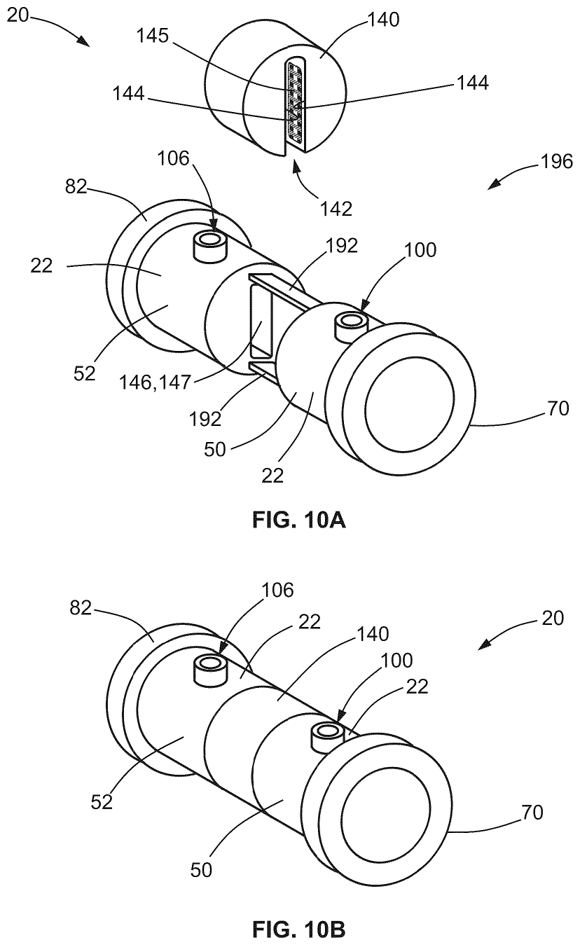

Additionally, the personal mobility/utility system 20 may further include an auxiliary battery 140 configured for installation between the first and second halves 50, 52 when the first and second halves 50, 52 are spaced apart from each other, as shown in FIG. 10A. The auxiliary battery 140 may include a radial slot 142 therein defined by opposed slot walls 144, such that when the auxiliary battery 140 is installed between the first and second halves 50, 52, the one or more telescoping rails 192 fit within the radial slot 142. At least one of the opposed slot walls 144 may include a cooling inlet 145 and at least one of the first and second halves 50, 52 may include a cooling port 146 for supplying cooled air 147 to the cooling inlet 145 when the auxiliary battery 140 is installed between the first and second halves 50, 52, as shown in FIG. 10B where the personal mobility/utility system 20 is in a collapsed position. This collapsed position is similar to the middle position illustrated in FIG. 9B, except that in FIG. 10B the collapsed position has each of the first and second halves 50, 52 disposed in contact with the auxiliary battery 140 which is disposed between the first and second halves 50, 52.

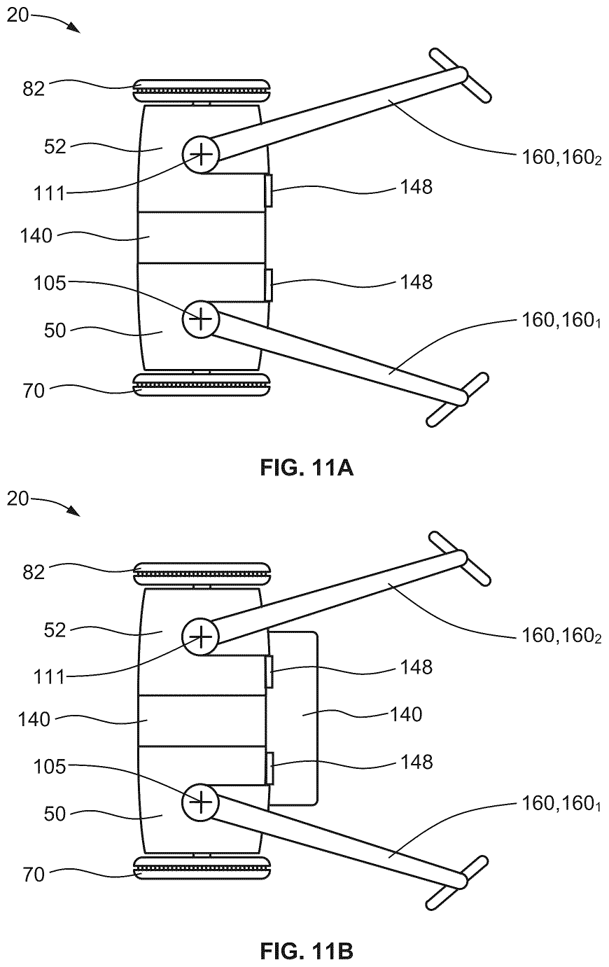

As shown in FIG. 11A, the personal mobility/utility system 20 may also include an auxiliary battery port 148 which is externally accessible through the housing 22, and which is directly or indirectly electrically connected with one or more of the at least one primary battery 134, 136 and the first and second dual-shaft electric motors 54, 64. In some configurations, the auxiliary battery port 148 may be disposed on the first side 28 or the second side 32 of the housing 22. As shown in FIG. 11B, an auxiliary battery 140 may be electrically connected with the personal mobility/utility system 20 via connection with the auxiliary battery port 148. Optionally, the housing 22 and/or the auxiliary battery 140 may be configured to mechanically support the auxiliary battery 140 and maintain a mechanical connection between the auxiliary battery 140 and the housing 22 while the auxiliary battery 140 is electrically connected with the auxiliary battery port 148.

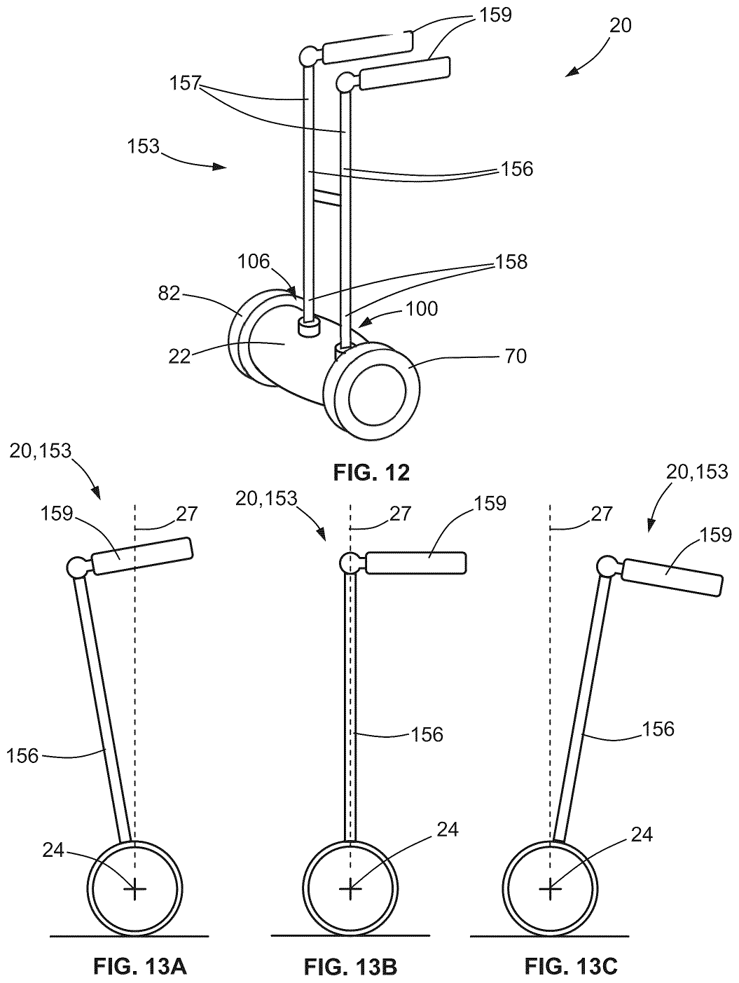

The personal mobility/utility system 20 may further include one or more modules 152, as illustrated in FIGS. 12-30 and as described in detail below. These modules 152 may include a walker module 153, an outrigger module 160, a cargo module 172, a seat module 178 and a wheel module 180. Some of these modules 152 may be used together with each other, as described in more detail below.

FIGS. 12 and 13A-C show a walker module 153 attached to personal mobility/utility system 20. The walker module 153 has an upright portion 156 with a top end 157 and a bottom end 158, with the bottom end 158 being configured for insertion into the first and second vertical apertures 100, 106, and handlebars 159 attached to the top end 157 of the upright portion 156. The upright portion 156 may include two vertical uprights which are inserted into both of the first and second vertical apertures 100, 106, as shown in FIG. 12, or it may include a single vertical upright whose bottom end is inserted into one or both of the vertical apertures 100, 106. The handlebars 159 may take the form of two separate handlebar segments (i.e., one for each hand of the user 10), or it may take the form of a single handlebar segment (such as a closed ring or ellipse) that is attached to the top end 157 of the upright portion 156.

With the walker module 153 inserted, a user 10 may simultaneously walk and hold onto the handlebars 159 of the personal mobility/utility system 20. If the sensor array 112 senses a forward push 120_{Mpu}, a backward/rearward pull 120_{Mpl} or a turn 120_{Mt} being exerted on the personal mobility/utility system 20 by the user 10, the controller 122 may then cause the first and second dual-shaft electric motors 54, 64 to engage so as to propel, steer or stop the personal mobility/utility system 20 in concert with the sensed motive inputs 120_{M} of the user 10. (In this sense, the personal mobility/utility system 20 may be viewed as acting to multiply or increase the user's pushing, pulling and turning efforts.) Also, if the sensor array 112 senses that the walker module 153 is tipping forward as in FIG. 13A or is tipping backward as in FIG. 13C, the controller 122 may then cause the first and second dual-shaft electric motors 54, 64 to engage so as to return the personal mobility/utility system 20 to an upright position 48 as in FIG. 13B and to maintain the personal mobility/utility system 20 in the upright position 48.

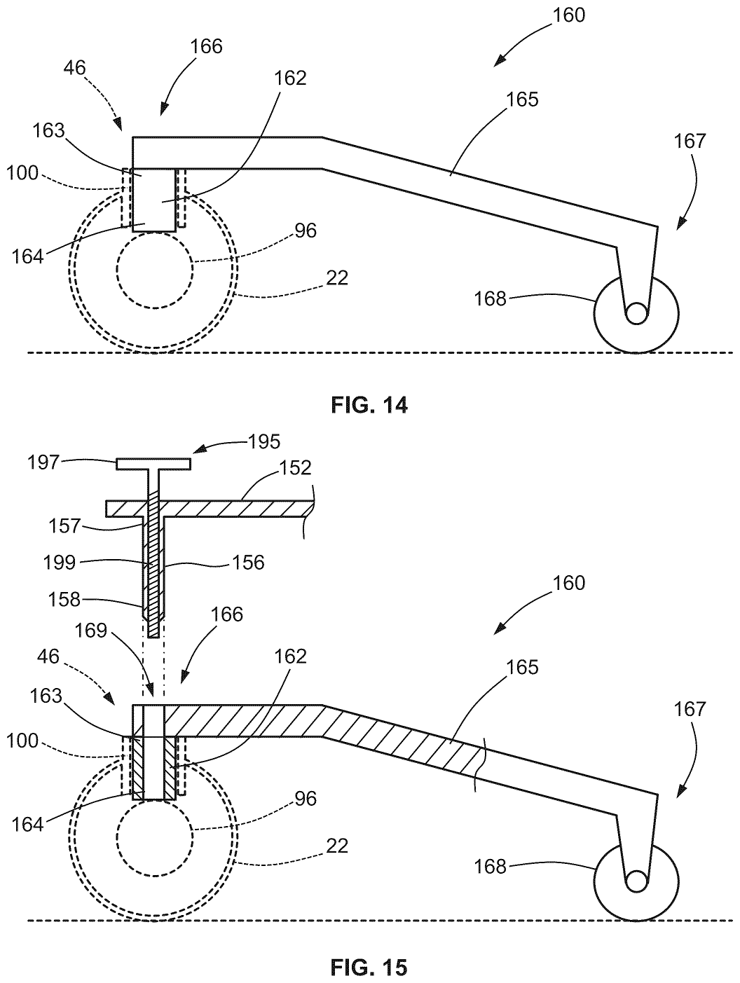

FIGS. 14-15 show two different but related embodiments of an outrigger module 160. Note that while FIGS. 14-15 each shows only a single outrigger module 160, in practice two outrigger modules 160 may be used at once, as shown in FIGS. 1A-B, 18-19, etc. Each outrigger module 160 has a vertical portion 162 with an upper end 163 and a lower end 164, with the lower end 164 being configured for insertion into one of the first and second vertical apertures 100, 106. The outrigger module 160 also has an arm portion 165, with a leading end 166 attached to the upper end 163 of the vertical portion 162 and a trailing end 167 opposite the leading end 166. Additionally, a rolling caster 168 is attached to the trailing end 167 of the arm portion 165.

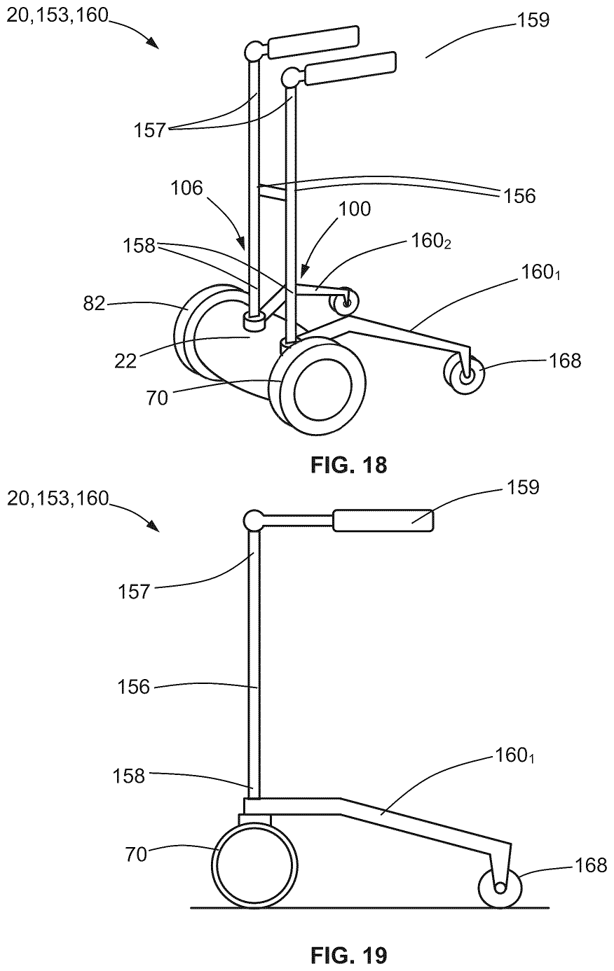

As shown in FIG. 15, the upper end 163 of the vertical portion 162 may have a vertically oriented socket 169 formed therein. The vertical socket 169 may be formed as a blind hole (which does not extend all the way through the vertical portion 162) or a through-hole (which does extend all the way through the vertical portion 162, as illustrated in FIG. 15). The vertical socket 169 is provided in the outrigger module 160 to allow additional modules 152 to be used with the outrigger module 160 as part of the personal mobility/utility system 20. These additional modules 152, as illustrated in FIGS. 18-30 and as described in detail below, may include the walker module 153 (introduced above), a cargo module 172, a seat module 178 and a wheel module 180, as discussed in more detail below. As illustrated in FIG. 15, the upright portion 156 of one of the foregoing modules 152 may be inserted into the vertical aperture 100 formed in the outrigger module 160. The upright portion 156 may have a long vertical hole therein through which a lifter element 195 may extend. The lifter element 195 may have an upper portion 197, which may contact or interface with another part of the same module 152 or with another device, and a threaded portion 199, which may engage with the module gear 96. As the module gear 96 is controllably rotated, the lifter element 195 may be selectably raised and lowered.

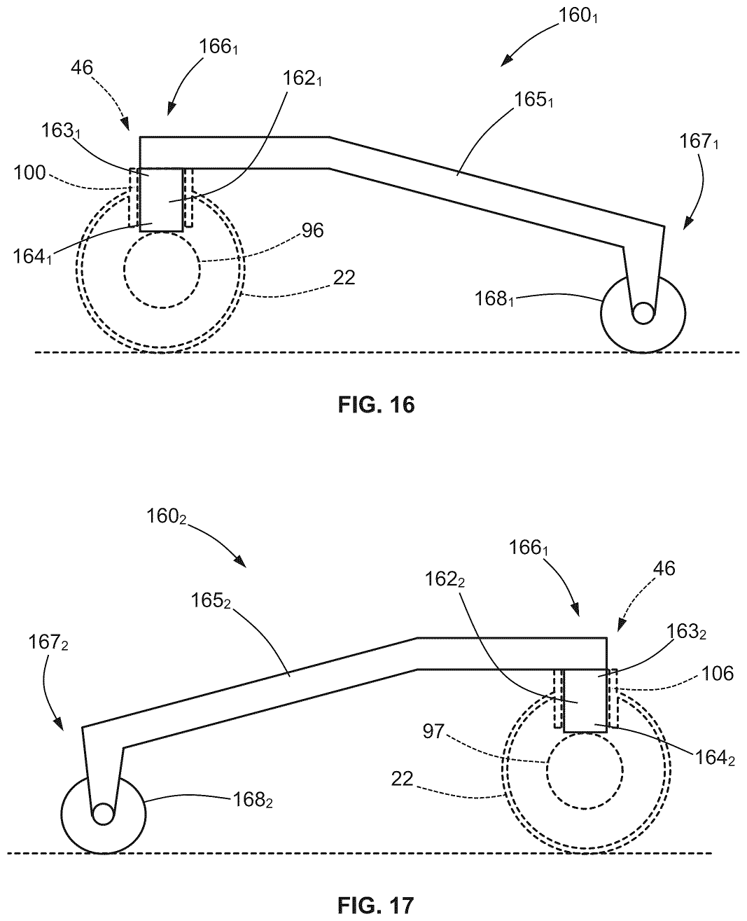

FIGS. 16-17 show schematic side views of first and second outrigger modules 160₁, 160₂, respectively. The first outrigger module 160₁ has a first vertical portion 162₁ with a first upper end 163₁ and a first lower end 164₁, with the first lower end 164₁ being configured for insertion into the first vertical aperture 100. The first outrigger module 160₁ also has a first arm portion 165₁ with a first leading end 166₁ attached to the first upper end 163₁ of the first vertical portion 162₁ and a first trailing end 167₁ opposite the first leading end 166₁, and a first caster 168₁ attached to the first trailing end 167₁. The second outrigger module 160₂ has a second vertical portion 162₂ with a second upper end 163₂ and a second lower end 164₂, with the second lower end 164₂ being configured for insertion into the second vertical aperture 106. The second outrigger module 160₂ also has a second arm portion 165₂ with a second leading end 166₂ attached to the second upper end 163₂ of the second vertical portion 162₂ and a second trailing end 167₂ opposite the second leading end 166₂, and a second caster 168₂ attached to the second trailing end 167₂. Although not shown in FIGS. 16-17, if a vertically oriented socket 169 is formed in each of the first and second outrigger modules 160₁, 160₂ like the outrigger module 160 shown in FIG. 15B, then a module 152 inserted into each of the sockets 169 may be engaged with the respective first or second module gear 96, 97.

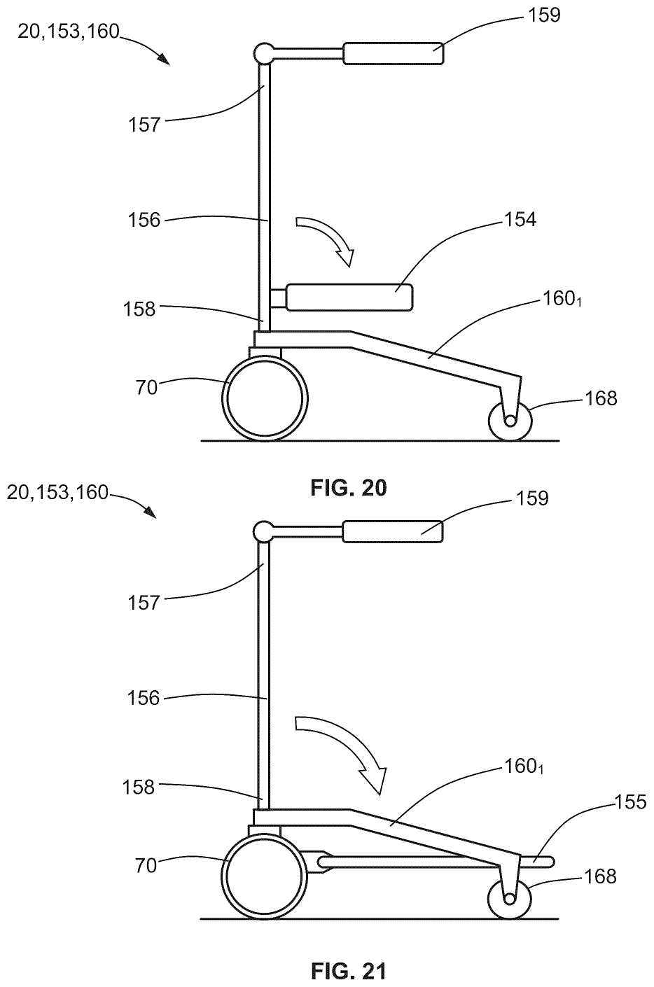

FIGS. 18-19 show the personal mobility/utility system 20 utilizing first and second outrigger modules 160₁, 160₂ in conjunction with a walker module 153. Here, the bottom end 158 of each upright portion 156 is inserted into a respective vertical socket 169, and a set of handlebars 159 is attached to the top end 157 of the upright portion 156. With the use of a walker module 153 along with the outrigger modules 160₁, 160₂, the personal mobility/utility system 20 may be more stable for some users 10 than if the walker module 153 were not used with the outrigger modules 160₁, 160₂. Additionally, FIG. 20 illustrates the inclusion of a jump seat 154 which may be folded down from a vertical storage position and into a horizontal seating position. The jump seat 154 may be permanently installed on the upright portion 156 of the walker module 153, or it may be installable and removable. With the inclusion of the jump seat 154, a user 10 may sit on the jump seat 154 and scoot along the floor with their feet. Further, FIG. 21 shows a platform 155 which also may be folded down from a vertical storage position and into a horizontal seating or standing position. The platform 155 may be permanently installed on the upright portion 156 of the walker module 153, or it may be installable and removable. With the inclusion of the platform 155, a user 10 may sit on the edge of the platform 155 and scoot along the floor with their feet, or they may stand on the platform 155 and use motive gestures, voice commands and the like to have the personal mobility/utility system 20 provide propulsion.

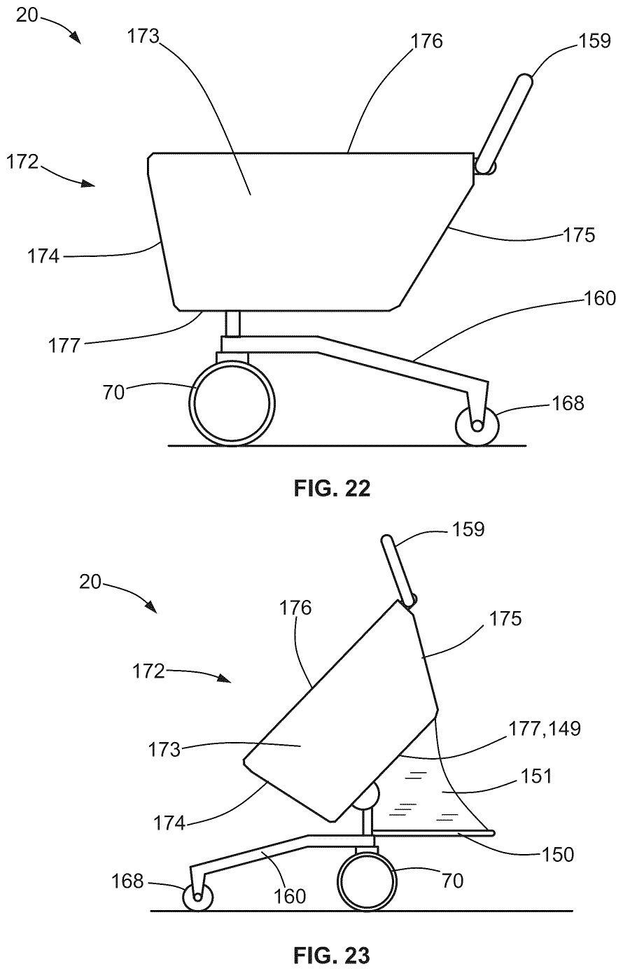

FIG. 22 shows the personal mobility/utility system 20 utilizing first and second outrigger modules 160₁, 160₂ in conjunction with a cargo module 172. The cargo module 172 includes a basket 173 having a front side 174, a back side 175, a top side 176 and a bottom side 177, with at least one of the front and bottom sides 174, 177 being attached to the top end 157 of an upright portion 156, and with a set of handlebars 159 attached to at least one of the top and back sides 176, 175 of the basket 173. With the inclusion of the cargo module 172, a user 10 may place items in the basket 173 and transport them in a hands-free manner while pushing, walking behind or riding on the personal mobility/utility system 20.

Optionally, as illustrated in FIG. 23, the cargo module 173 may include a first rigid surface 149 attached to or formed as a part of the bottom side 177 of the basket, and a second rigid surface 150 attached to or formed as a part of the upright portion 156 and extending generally horizontally. The first and second rigid surfaces 149, 150 are pivotably attached to each other adjacent the upright portion 156, such that the basket 173 and its contents may be dumped out by rotating the basket 173 and the attached first rigid surface 149 with respect to the stationary second rigid surface 150. (Alternatively, the first and second rigid surfaces 149, 150 may be pivotably attached to each other opposite or distal from the upright portion 156.) This dumping motion may be assisted by an inflatable bladder or bellows 151 sealably attached between the first and second rigid surfaces 149, 150. Alternatively, lifter elements 195 may be inserted into through-holes formed in the second rigid surface 150 of the cargo module 173 and into the vertical sockets 169 formed in the outrigger module 160, such that the threaded portion 199 engages the module gear 96; then, when the module gear 96 rotates and lifts the lifter element 195, the upper portion 197 of the lifter element 195 may push upward on the first rigid surface 149 to facilitate dumping of the basket 173.

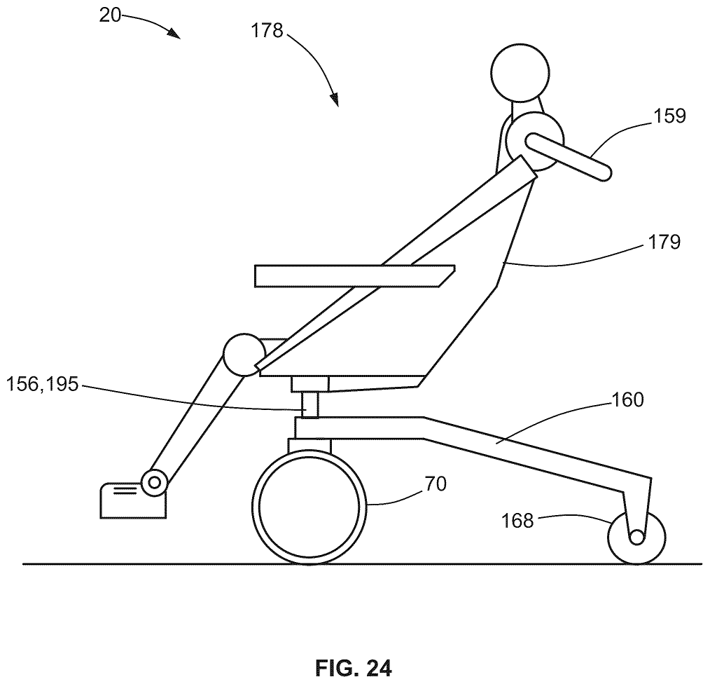

FIG. 24 shows the personal mobility/utility system 20 utilizing first and second outrigger modules 160₁, 160₂ in conjunction with a seat module 178. Here, a seat 179 is attached to the top ends 157 of two upright portions 156, with the bottom ends 158 of the upright portions 156 being inserted into the vertical sockets 169 that are formed in the first and second outrigger modules 160₁, 160₂. The seat 179 may have a generally horizontal seat support portion, a generally vertical back support portion attached to a rear edge of the seat support portion, a headrest portion attached to an upper end of the back support portion, and left and right generally horizontal arm supports attached to the back support portion. Optionally, the seat module 178 may also include left and right leg supports attached to a forward edge of the seat support portion. Two or more of the portions and elements of the seat portion 178 may be fabricated as a single unitary piece; for example, the seat support portion and the back support portion may be molded or fabricated as a single unit. At a distal end of one or both of the arms, various user input and control devices may be disposed, such as buttons, keyboards, keypads, joysticks, microphones, display devices and the like. With the inclusion of the seat module 178, a user 10 may sit comfortably on or within the seat module 178, and either scoot along the floor with their feet or place their feet on the leg supports and use motive gestures, voice commands and the like to have the personal mobility/utility system 20 provide propulsion.

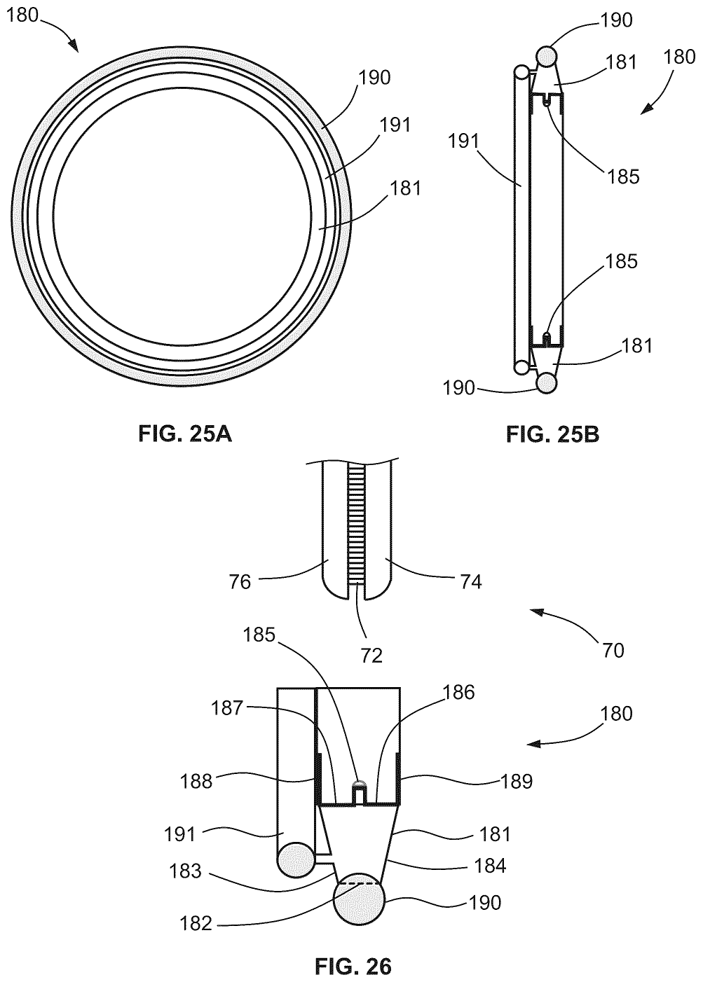

Turning now to FIGS. 25A-28, two different but related embodiments of a wheel module 180 are shown. In both embodiments, the personal mobility/utility system 20 utilizes first and second outrigger modules 160₁, 160₂.

As illustrated in the first embodiment of the wheel module 180 shown in FIGS. 25A-26, each of the first and second traction wheels 70, 82 may include a respective externally toothed portion 72, 84 sandwiched between a respective inner tire portion 74, 86 and a respective outer tire portion 76, 88, with the personal mobility/utility system 20 further including a wheel module 180. The wheel module 180 has a rim 181, a tire 190 attached to an outer circumferential surface 182 of the rim 181, and a handrim 191 attached to an outer face 183 of the rim 181. The rim 181 may have an internally toothed portion 185 sandwiched between a first inner circumferential surface 186 and a second inner circumferential surface 187, an outer wall 188 extending radially inward from the outer face 183 and an inner wall 189 extending radially inward from an inner face 184 of the rim 181.

One of the first and second traction wheels 70, 82 may be disposed in contact with the wheel module 180 such that the respective externally toothed portion 72, 84 engages with the internally toothed portion 185, the respective inner tire portion 74, 86 is disposed in contact with the first inner circumferential surface 186 between the internally toothed portion 185 and the inner wall 189, and the respective outer tire portion 76, 88 is disposed in contact with the second inner circumferential surface 187 between the internally toothed portion 185 and the outer wall 188. Additionally, the upper end 163 of the vertical portion 162 may have a vertically oriented socket 169 formed therein, and the personal mobility/utility system 20 may further include a seat module 178 inserted into the vertical sockets 169 of the first and second outrigger modules 160₁, 160₂.

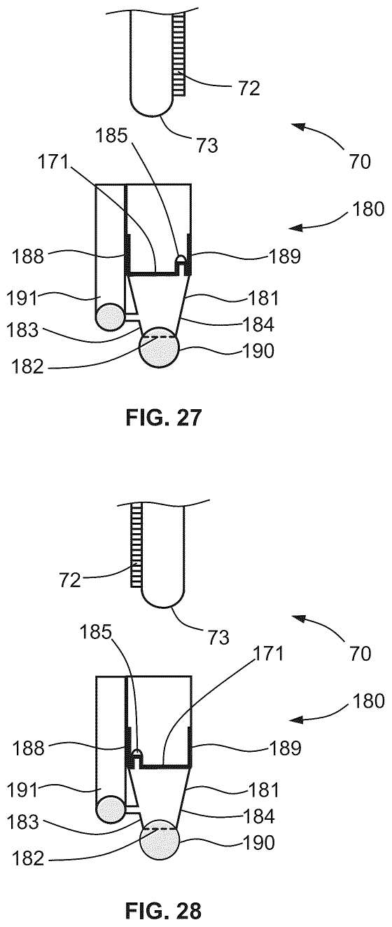

Alternatively, as illustrated in the second embodiment of the wheel module 180 shown in FIGS. 27-28, each of the first and second traction wheels 70, 82 may include a respective tire portion 73, 85 and a respective externally toothed portion 72, 84 on a respective inner side 80, 92 of the respective traction wheel 70, 82 and/or on a respective outer side 81, 93 of the respective traction wheel 70, 82. In this arrangement, the personal mobility/utility system 20 may include a wheel module 180 having a rim 181, a tire 190 attached to an outer circumferential surface 182 of the rim 181, and a handrim 191 attached to an outer face 183 of the rim 181. The rim 181 may have an internally toothed portion 185 adjacent and inside an inner wall 189 extending radially inward from an inner face 184 of the rim 181 (as shown in FIG. 27) and/or adjacent and inside an outer wall 188 extending radially inward from the outer face 183 of the rim 181 (as shown in FIG. 28), and an inner circumferential surface 171 between the inner wall 189 and the outer wall 188. One of the first and second traction wheels 70, 82 may be disposed in contact with the wheel module 180 such that the respective externally toothed portion 72, 84 engages with the internally toothed portion 185 and the respective tire portion 73, 85 is disposed in contact with the inner circumferential surface 171 between the inner wall 189 and the outer wall 188.

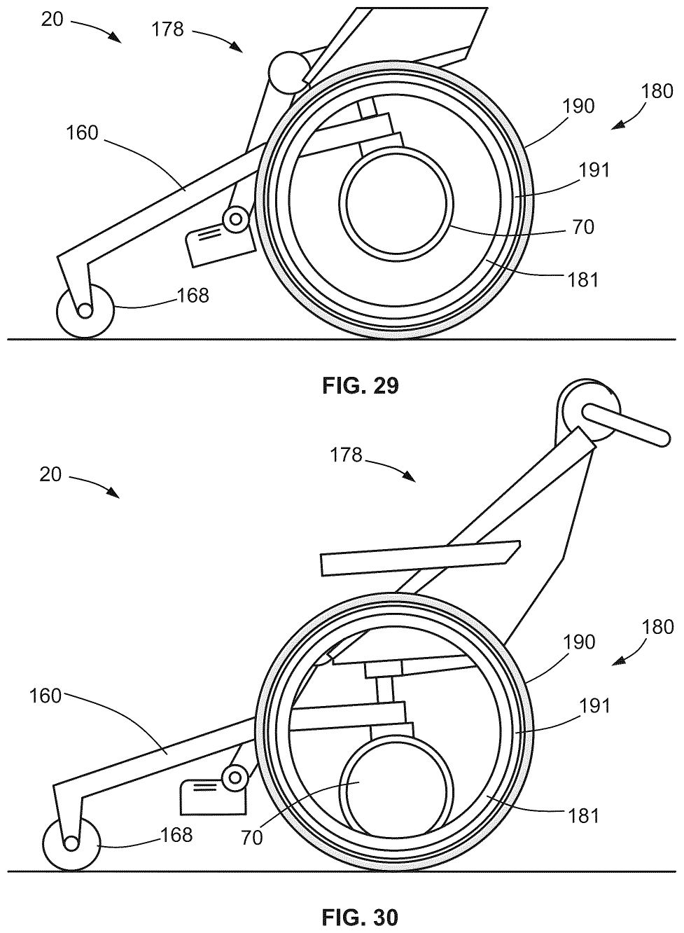

In either of these two embodiments of the wheel module 180, the personal mobility/utility system 20 may be assembled by disposing one of the traction wheels 70, 82 inside the rim 181 of the wheel module 180, as shown in FIG. 29, and then engaging the traction wheel 70, 82 with the rim 181, such that the externally toothed portion 72, 84 of the traction wheel 70, 82 engages with the internally toothed portion 185 of the wheel module 180, as shown in FIG. 30.

With the inclusion of either of the above embodiments of the wheel module 180, plus inclusion of the seat module 178 and the first and second outrigger modules 160₁, 160₂, a user 10 may utilize the personal mobility/utility system 20 in a manner similar to a wheelchair. That is, with a wheel module 180 installed on either side of the seat module 178, the user 10 may sit on or within the seat module 178 and use their hands to manipulate the handrims 191 on both sides of the personal mobility/utility system 20 to propel, turn and stop the personal mobility/utility system 20. Additionally, when motive gestures such as pushing, pulling, turning and stopping, or any other user inputs (such as voice commands), are detected by the sensor array 112, the personal mobility/utility system 20 may selectably engage the first and second dual-shaft electric motors 54, 64 to provide added propulsion 127, steering 128 and braking 129 for the personal mobility/utility system 20.

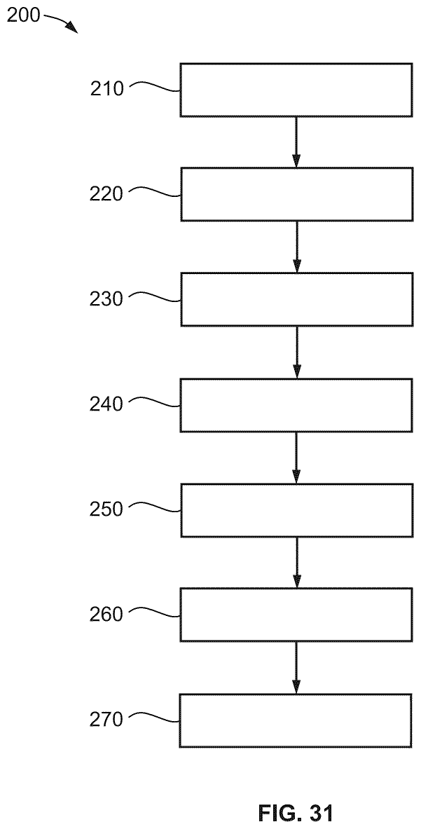

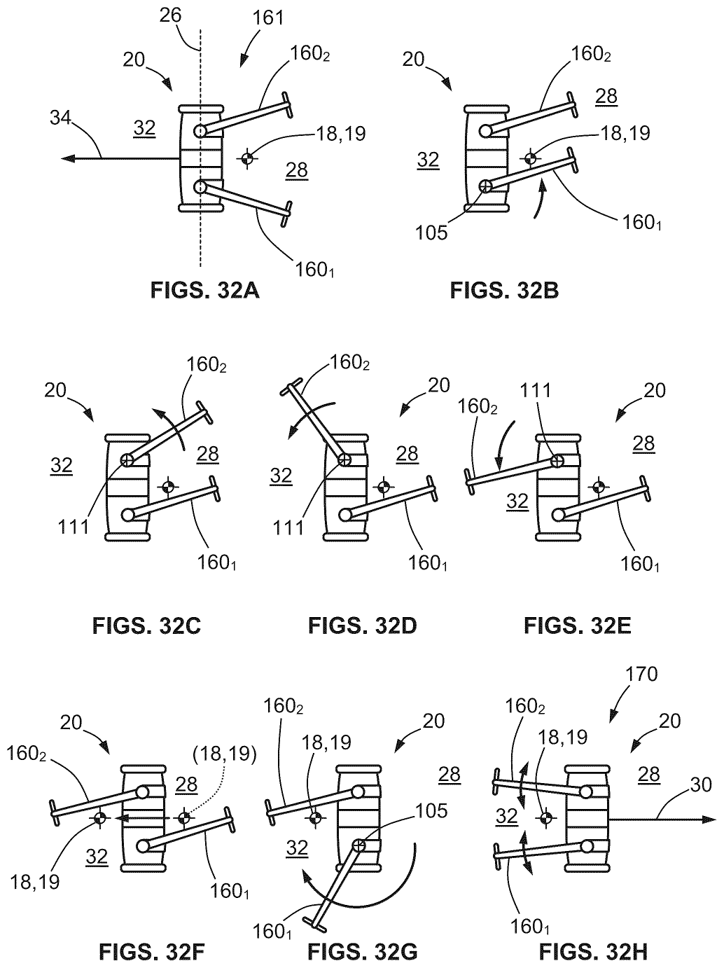

Turning now to FIG. 31, a flowchart is shown for a method 200 of maneuvering a personal mobility/utility system 20. Relatedly, FIGS. 32A-H illustrate a sequence of positions for the steps shown in the flowchart of FIG. 31. In FIGS. 31-32H, a first outrigger module 160₁ is attached to a top 46 of the personal mobility/utility system 20 (e.g., atop the housing 22) at a first pivot point 105, and a second outrigger module 160₂ is attached to the top 46 at a second pivot point 111, with the personal mobility/utility system 20 being configured to carry a payload 18 having a payload center of gravity 19.

At step 210 (see FIG. 32A), the personal mobility/utility system 20 is positioned in a first position 161, wherein the payload center of gravity 19 is located on the first side 28 and the first and second outrigger modules 1061, 160₂ are disposed on the first side 28. In this first position 161, the personal mobility/utility system 20 may be oriented and rigged for movement in the second direction 34. At step 220 (see FIG. 32B), the first outrigger module 160₁ is rotated about the first pivot point 105 and toward the midline 36. At step 230 (see FIGS. 32C-E), the second outrigger module 160₂ is rotated about the second pivot point 111 and onto the second side 32. At step 240 (see FIG. 32F), the payload 18 is repositioned so as to move the payload center or gravity 19 from the first side 28 to the second side 32. (Note in FIG. 32F that reference numerals 18 and 19 are enclosed within parentheses, and the associated lead line is shown as a dotted line; this is done to indicate the former or starting position of the payload 18 and its center of gravity 19 at the start of step 240, while the solid reference numerals 18 and 19 and the associated solid lead line indicate the ending position of the payload 18 and its center of gravity 19 at the completion of step 240.) And at step 250 (see FIG. 32G), the first outrigger module 160₁ is rotated about the first pivot point 105 from the first side 28 to the second side 32, placing the personal mobility/utility system 20 in a second position 170 (see FIG. 32H). Optionally, at step 260, the positions of the first and second outrigger modules 160₁, 160₂ may be adjusted so as to provide stable support for the payload 18, and at step 270, the personal mobility/utility system 20 may be propelled in the first direction 30.

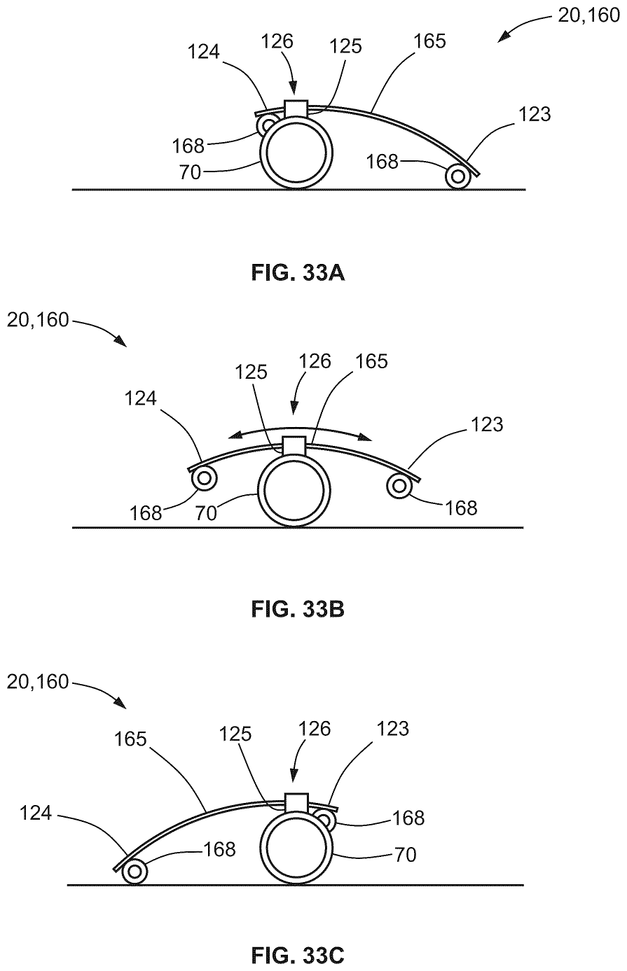

FIGS. 33A-C show a sequence of positions of an outrigger 160 for an alternative method of maneuvering a personal mobility/utility system 20. In this alternative method, each outrigger module 160 has an arcuate arm portion 165 having a first arm portion end 123 and a second arm portion end 124, with a respective caster 168 at each of the first and second arm portion ends 123, 124. Additionally, the housing 22 has a respective sleeve bearing 125 located at the top 46 of the housing 22 for each outrigger module 160, with each of the outrigger modules 160 slidably captured within its respective sleeve bearing 125. Each sleeve bearing 125 and its respective outrigger module 160 may also include a respective translation mechanism 126 which, when activated by the controller 122, causes the respective outrigger module 160 to arcuately translate from the first side 28 to the second side 32, and vice versa.

For example, the outrigger module 160 in FIG. 33A is shown with the caster 168 on the first arm portion end 123 being in contact with the floor or supporting surface, and with the caster 168 on the second arm portion end 124 being disposed near or in contact with the sleeve bearing 125. In FIG. 33B, the translation mechanism 126 is engaged to cause the outrigger module 160 to arcuately translate through the sleeve bearing 125. (As an example, this arcuate translation may be facilitated by, and the translation mechanism 126 may include, a rack of gear teeth being disposed on an underside surface of the arm portion 165, with a pinion gear being adjacent or formed as a part of the sleeve bearing 125, such that each module gear 96, 97 may engage directly or indirectly with the pinion gear so as to selectably cause the outrigger module 160 to arcuately translate back-and-forth between the first and second sides 28, 32.) And in FIG. 33C, the outrigger module 160 has arcuately translated such that the caster 168 on the second arm portion end 124 is in contact with the floor or supporting surface, and the caster 168 on the first arm portion end 123 is disposed near or in contact with the sleeve bearing 125.

It may be noted that a variety of software, controls, tracking and communications features may be incorporated into the personal mobility/utility system 20. For example, when the personal mobility/utility system 20 includes a cargo module 172, a user 10 may walk or roll in a wheelchair along with the personal mobility/utility system 20 without holding onto or manually guiding the personal mobility/utility system 20, and the personal mobility/utility system 20 may autonomously travel along with the user 10 by the personal mobility/utility system 20 sensing and following the user 10. This sensing of the user 10 and their speed and trajectory may be accomplished by incorporating a suitable wireless sensor 114 as part of the sensor array 112 which detects the position, speed and trajectory of the user 10. For instance, such a sensor 114 may be a vision-based sensor, an electromagnetic sensor or the like, including the use of WiFi, Bluetooth, machine-vision or other technologies. Additionally or alternatively, the user 10 may wear a smart watch, wear or carry an electromagnetic beacon (e.g., in the form of a bracelet or necklace), activate an app on their phone, or take similar actions which provide a signal of the user's position and movements, which the sensor array 112 may detect and track in order to propel, stop and turn the personal mobility/utility system 20.

As one having skill in the relevant art will appreciate, the system 20 and method 200 of the present disclosure may be presented or arranged in a variety of different configurations and embodiments.

According to one embodiment, a personal mobility/utility system 20 includes: (i) a generally elongate housing 22 having a center 24, a longitudinal axis 26 passing through the center 24, and a midline 36 passing through the center 24 and running perpendicular to the longitudinal axis 26 and defining opposed first and second ends 42, 44 of the housing 22; (ii) first and second dual-shaft electric motors 54, 64 disposed within the housing 22 at the first and second ends 42, 44, respectively, with each having a respective inboard shaft 56, 66 extending toward the midline 36 and a respective outboard shaft 60, 68 extending opposite the respective inboard shaft 56, 66, wherein the respective inboard and outboard shafts 56, 60, 66, 68 are aligned parallel or colinear with the longitudinal axis 26; (iii) first and second traction wheels 70, 82 rotatably attached to the first and second output shafts 60, 68, respectively, via respective first and second wheel clutches 94, 95 and extending outside the housing 22 at the first and second ends 42, 44, respectively; (iv) first and second module gears 96, 97 rotatably attached to the first and second inboard shafts 56, 66, respectively, via respective first and second module clutches 98, 99; (v) first and second generally tubular vertical apertures 100, 106 formed in the housing 22 and having respective first and second top openings 102, 108 defined at a top 46 of the housing 22 and respective first and second bottom openings 104, 110 opposite the respective first and second top openings 102, 108 and situated adjacent the first and second module gears 96, 97, respectively; (vi) a sensor array 112 disposed on or within the housing 22 for detecting inputs 120 including one or more of motive inputs 120_{M} from a user 10, command inputs 120_{C} from the user 10, environmental inputs 120_{E} from a surrounding environment 12 and attitude inputs 120_{A} from an attitude sensor 116, and for providing one or more sensor signals 118 indicative of the detected inputs 120; and (vii) a controller 122 disposed within the housing 22 for receiving the one or more sensor signals 118 and for controlling the first and second dual-shaft electric motors 54, 64, the first and second wheel clutches 94, 95 and the first and second module clutches 98, 99 so as to provide propulsion 127, steering 128 and braking 129 of the personal mobility/utility system 20 by selective engagement of the first and second dual-shaft electric motors 54, 64 and the first and second wheel clutches 94, 95, provide one or more of extension 130, retraction 131 and rotation 132 of a module 152 by selective engagement of the first and second dual-shaft electric motors 54, 64 and the first and second module clutches 98, 99 when the module 152 is inserted into one or both of the first and second vertical apertures 100, 106 and is engaged with one or both of the first and second module gears 96, 97, and maintain the personal mobility/utility system 20 in an upright position 48.

The personal mobility/utility system 20 may further include at least one primary battery 134, 136 disposed within the housing 22 and configured for providing electrical power 138 to the first and second dual-shaft electric motors 54, 64, the sensor array 112 and the controller 122.

The motive inputs 120_{M} may include one or more of a push 120_{Mpu} exerted upon the personal mobility/utility system 20 by the user 10, a pull 120_{Mpl} exerted upon the personal mobility/utility system 20 by the user 10 and a turn 120_{Mt} exerted upon the personal mobility/utility system 20 by the user 10.

The command inputs 120_{C} may include one or more of a voice command 120_{Cvc}, a button press 120_{Cbp}, a button release 120_{Cbr}, a joystick manipulation 120_{Cjm}, a joystick release 120_{Cjr}, a knob turn 120_{Ckt}, a toggle manipulation 120_{Ctm}, a selector manipulation 120_{Csel}, a slider manipulation 120_{Csli}, a caliper squeeze 120_{Ccs} and a caliper release 120_{Ccr}.

The environmental inputs 120_{E} may include one or more of a proximity input 120_{Ep} indicative of a bearing B, a proximity P and/or an external location EL of an object 14, an obstacle 15 or a geofence border 16 within the surrounding environment 12, a geo-spatial positioning signal 11 for determining a current location CL of the personal mobility/utility system 20, a warning 13 from a warning device 13_{dev}, and a navigation command or instruction 17 from a navigation device 17_{dev}.

The attitude inputs 120_{A} may include one or both of a forward degree of pitch 120_{Af} of the personal mobility/utility system 20 and a rearward degree of pitch 120_{Ar} of the personal mobility/utility system 20.

The controller 122 may be further configured for one or more of: determining a current location CL of the personal mobility/utility system 20; determining one or more of a bearing B, a proximity P and an external location EL of an object 14, an obstacle 15 or a geofence border 16 within the surrounding environment 12; causing the personal mobility/utility system 20 to identify, avoid, approach and/or interact with the object 14, the obstacle 15 or the geofence border 16; and causing the personal mobility/utility system 20 to follow and/or deviate from a predetermined path PP.

The personal mobility/utility system 20 may further include a walker module 153 having an upright portion 156 with a top end 157 and a bottom end 158 with the bottom end 158 being configured for insertion into the first and second vertical apertures 100, 106, and handlebars 159 attached to the top end 157 of the upright portion 156.

The personal mobility/utility system 20 may further include an outrigger module 160 having a vertical portion 162 with an upper end 163 and a lower end 164 with the lower end 164 being configured for insertion into one of the first and second vertical apertures 100, 106, an arm portion 165 with a leading end 166 attached to the upper end 163 of the vertical portion 162 and a trailing end 167 opposite the leading end 166, and a caster 168 attached to the trailing end 167 of the arm portion 165.

The upper end 163 of the vertical portion 162 may have a vertically oriented socket 169 formed therein, and the personal mobility/utility system 20 may further include a walker module 153 having an upright portion 156 with a top end 157 and a bottom end 158 with the bottom end 158 being configured for insertion into the socket 169, and handlebars 159 attached to the top end 157 of the upright portion 156. Alternatively, the personal mobility/utility system 20 may further include a cargo module 172 having an upright portion 156 with a top end 157 and a bottom end 158 with the bottom end 158 being configured for insertion into the socket 169, a basket 173 with a front side 174, a back side 175, a top side 176 and a bottom side 177 with at least one of the front and bottom sides 174, 177 being attached to the top end 157 of the upright portion 156, and handlebars 159 attached to at least one of the top and back sides 176, 175 of the basket 173. As another alternative, the personal mobility/utility system 20 may include a seat module 178 having an upright portion 156 with a top end 157 and a bottom end 158 with the bottom end 158 being configured for insertion into the socket 169, and a seat 179 attached to the top end 157 of the upright portion 156.

Each of the first and second traction wheels 70, 82 may include a respective externally toothed portion 72, 84 sandwiched between a respective inner tire portion 74, 86 and a respective outer tire portion 76, 88, and the personal mobility/utility system 20 may further include a wheel module 180 having a rim 181, a tire 190 attached to an outer circumferential surface 182 of the rim 181, and a handrim 191 attached to an outer face 183 of the rim 181. The rim 181 may have an internally toothed portion 185 sandwiched between a first inner circumferential surface 186 and a second inner circumferential surface 187, an outer wall 188 extending radially inward from the outer face 183 and an inner wall 189 extending radially inward from an inner face 184 of the rim 181. One of the first and second traction wheels 70, 82 may be disposed in contact with the wheel module 180 such that the respective externally toothed portion 72, 84 engages with the internally toothed portion 185, the respective inner tire portion 74, 86 is disposed in contact with the first inner circumferential surface 186 between the internally toothed portion 185 and the inner wall 189, and the respective outer tire portion 76, 88 is disposed in contact with the second inner circumferential surface 187 between the internally toothed portion 185 and the outer wall 188. Additionally, the upper end 163 of the vertical portion 162 may have a vertically oriented socket 169 formed therein, and the personal mobility/utility system 20 may further include a seat module 178 having an upright portion 156 with a top end 157 and a bottom end 158 with the bottom end 158 being configured for insertion into the socket 169, and a seat 179 attached to the top end 157 of the upright portion 156.

Alternatively, each of the first and second traction wheels 70, 82 may include a respective tire portion 73, 85 and a respective externally toothed portion 72, 84 on a respective inner side 80, 92 and/or on a respective outer side 81, 93 of the respective traction wheel 70, 82. In this arrangement, the personal mobility/utility system 20 may include a wheel module 180 having a rim 181, a tire 190 attached to an outer circumferential surface 182 of the rim 181, and a handrim 191 attached to an outer face 183 of the rim 181. The rim 181 may have an internally toothed portion 185 adjacent and inside an inner wall 189 extending radially inward from an inner face 184 of the rim 181 and/or adjacent and inside an outer wall 188 extending radially inward from the outer face 183 of the rim 181, and an inner circumferential surface 171 between the inner wall 189 and the outer wall 188. One of the first and second traction wheels 70, 82 may be disposed in contact with the wheel module 180 such that the respective externally toothed portion 72, 84 engages with the internally toothed portion 185 and the respective tire portion 73, 85 is disposed in contact with the inner circumferential surface 171 between the inner wall 189 and the outer wall 188.

The personal mobility/utility system 20 may be separable into a first half 50 which includes the first dual-shaft electric motor 54, the first traction wheel 70, the first module gear 96 and the first generally tubular vertical aperture 100, and a second half 52 which includes the second dual-shaft electric motor 64, the second traction wheel 82, the second module gear 97 and the second generally tubular vertical aperture 106, and the personal mobility/utility system 20 may further include one or more telescoping rails 192 each having a respective first rail end 193 captured within the first half 50 and a respective second rail end 194 captured within the second half 52, wherein each of the one or more telescoping rails 192 is configured for extending so as to dispose the first and second halves 50, 52 spaced apart from each other and for retracting so as to dispose the first and second halves 50, 52 in contact with each other. Additionally, the personal mobility/utility system 20 may further include an auxiliary battery 140 configured for installation between the first and second halves 50, 52 when the first and second halves 50, 52 are spaced apart from each other. The auxiliary battery 140 may include a radial slot 142 therein defined by opposed slot walls 144, such that when the auxiliary battery 140 is installed between the first and second halves 50, 52, the one or more telescoping rails 192 fit within the radial slot 142. At least one of the opposed slot walls 144 may include a cooling inlet 145 and at least one of the first and second halves 50, 52 may include a cooling port 146 for supplying cooled air 147 to the cooling inlet 145 when the auxiliary battery 140 is installed between the first and second halves 50, 52.

The personal mobility/utility system 20 may also include an auxiliary battery port 148 externally accessible through the housing 22 and directly or indirectly electrically connected with one or more of the at least one primary battery 134, 136 and the first and second dual-shaft electric motors 54, 64, and an auxiliary battery 140 configured for electrical connection with the auxiliary battery port 148.

According to another embodiment, a personal mobility/utility system 20 includes: (i) a generally elongate housing 22 having a center 24, a longitudinal axis 26 passing through the center 24, and a midline 36 passing through the center 24 and running perpendicular to the longitudinal axis 26 and defining opposed first and second ends 42, 44 of the housing 22; (ii) first and second dual-shaft electric motors 54, 64 disposed within the housing 22 at the first and second ends 42, 44, respectively, with each having a respective inboard shaft 56, 66 extending toward the midline 36 and a respective outboard shaft 60, 68 extending opposite the respective inboard shaft 56, 66, wherein the respective inboard and outboard shafts 56, 60, 66, 68 are aligned parallel or colinear with the longitudinal axis 26; (iii) first and second traction wheels 70, 82 rotatably attached to the first and second output shafts 60, 68, respectively, via respective first and second wheel clutches 94, 95 and extending outside the housing 22 at the first and second ends 42, 44, respectively; (iv) first and second module gears 96, 97 rotatably attached to the first and second inboard shafts 56, 66, respectively, via respective first and second module clutches 98, 99; (v) first and second generally tubular vertical apertures 100, 106 formed in the housing 22 and having respective first and second top openings 102, 108 defined at a top 46 of the housing 22 and respective first and second bottom openings 104, 110 opposite the respective first and second top openings 102, 108 and situated adjacent the first and second module gears 96, 97, respectively; (vi) a sensor array 112 disposed on or within the housing 22 for detecting inputs 120 including one or more of motive inputs 120_{M} from a user 10, command inputs 120_{C} from the user 10, environmental inputs 120_{E} from a surrounding environment 12 and attitude inputs 120_{A} from an attitude sensor 116, and for providing one or more sensor signals 118 indicative of the detected inputs 120; (vii) a controller 122 disposed within the housing 22 for receiving the one or more sensor signals 118 and for controlling the first and second dual-shaft electric motors 54, 64, the first and second wheel clutches 94, 95 and the first and second module clutches 98, 99 so as to provide propulsion 127, steering 128 and braking 129 of the personal mobility/utility system 20 by selective engagement of the first and second dual-shaft electric motors 54, 64 and the first and second wheel clutches 94, 95, provide one or more of extension 130, retraction 131 and rotation 132 of a module 152 by selective engagement of the first and second dual-shaft electric motors 54, 64 and the first and second module clutches 98, 99 when the module 152 is inserted into one or both of the first and second vertical apertures 100, 106 and is engaged with one or both of the first and second module gears 96, 97, and maintain the personal mobility/utility system 20 in an upright position 48; (viii) at least one primary battery 134, 136 disposed within the housing 22 and configured for providing electrical power 138 to the first and second dual-shaft electric motors 54, 64, the sensor array 112 and the controller 122; (ix) a first outrigger module 160₁ having a first vertical portion 162₁ with a first upper end 163₁ and a first lower end 164₁ with the first lower end 164₁ being configured for insertion into the first vertical aperture 100, a first arm portion 165₁ with a first leading end 166₁ attached to the first upper end 163₁ of the first vertical portion 162₁ and a first trailing end 167₁ opposite the first leading end 166₁, and a first caster 168₁ attached to the first trailing end 167₁ of the first arm portion 165₁; and (x) a second outrigger module 160₂ having a second vertical portion 162₂ with a second upper end 163₂ and a second lower end 164₂ with the second lower end 164₂ being configured for insertion into the second vertical aperture 106, a second arm portion 165₂ with a second leading end 166₂ attached to the second upper end 163₂ of the second vertical portion 162₂ and a second trailing end 167₂ opposite the second leading end 166₂, and a second caster 168₂ attached to the second trailing end 167₂ of the second arm portion 165₂.

According to yet another embodiment, a method 200 for maneuvering a personal mobility/utility system 20 is provided. The personal mobility/utility system 20 has a center 24, a longitudinal axis 26 passing through the center 24 and defining a first side 28 and a second side 32, a midline 36 passing through the center 24 and running perpendicular to the longitudinal axis 26, a first outrigger module 160₁ attached to a top 46 of the personal mobility/utility system 20 at a first pivot point 105, and a second outrigger module 160₂ attached to the top 46 at a second pivot point 111, wherein the personal mobility/utility system 20 is configured to carry a payload 18 having a payload center of gravity 19. The method 200 includes: (i) at step 210, positioning the personal mobility/utility system 20 in a first position 161, wherein the payload center of gravity 19 is located on the first side 28 and the first and second outrigger modules 160₁, 160₂ are disposed on the first side 28; (ii) at step 220, rotating the first outrigger module 160₁ about the first pivot point 105 and toward the midline 36; (iii) at step 230, rotating the second outrigger module 160₂ about the second pivot point 111 and onto the second side 32; (iv) at step 240, repositioning the payload 18 so as to move the payload center or gravity 19 from the first side 28 to the second side 32; and (v) at step 250, rotating the first outrigger module 160₁ about the first pivot point 105 from the first side 28 to the second side 32.

While various steps of the method 200 have been described as being separate blocks, and various functions of the system 20 have been described as being separate modules or elements, it may be noted that two or more steps may be combined into fewer blocks, and two or more functions may be combined into fewer modules or elements. Similarly, some steps described as a single block may be separated into two or more blocks, and some functions described as a single module or element may be separated into two or more modules or elements. Additionally, the order of the steps or blocks described herein may be rearranged in one or more different orders, and the arrangement of the functions, modules and elements may be rearranged into one or more different arrangements.

As used herein, a “module” may include hardware and/or software, including executable instructions, for receiving one or more inputs, processing the one or more inputs, and providing one or more corresponding outputs. Also note that at some points throughout the present disclosure, reference may be made to a singular input, output, element, etc., while at other points reference may be made to plural/multiple inputs, outputs, elements, etc. Thus, weight should not be given to whether the input(s), output(s), element(s), etc. are used in the singular or plural form at any particular point in the present disclosure, as the singular and plural uses of such words should be viewed as being interchangeable, unless the specific context dictates otherwise.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A personal mobility/utility system, comprising:
a generally elongate housing having a center, a longitudinal axis passing through the center, and a midline passing through the center and running perpendicular to the longitudinal axis and defining opposed first and second ends of the housing;
first and second dual-shaft electric motors disposed within the housing at the first and second ends, respectively, with each having a respective inboard shaft extending toward the midline and a respective outboard shaft extending opposite the respective inboard shaft, wherein the respective inboard and outboard shafts are aligned parallel or colinear with the longitudinal axis;
first and second traction wheels rotatably attached to the first and second output shafts, respectively, via respective first and second wheel clutches and extending outside the housing at the first and second ends, respectively;
first and second module gears rotatably attached to the first and second inboard shafts, respectively, via respective first and second module clutches;
first and second generally tubular vertical apertures formed in the housing and having respective first and second top openings defined at a top of the housing and respective first and second bottom openings opposite the respective first and second top openings and situated adjacent the first and second module gears, respectively;
a sensor array disposed on or within the housing for detecting inputs including one or more of motive inputs from a user, command inputs from the user, environmental inputs from a surrounding environment and attitude inputs from an attitude sensor, and for providing one or more sensor signals indicative of the detected inputs; and
a controller disposed within the housing for receiving the one or more sensor signals and for controlling the first and second dual-shaft electric motors, the first and second wheel clutches and the first and second module clutches so as to:
provide propulsion, steering and braking of the personal mobility/utility system by selective engagement of the first and second dual-shaft electric motors and the first and second wheel clutches;
provide one or more of extension, retraction and rotation of a module by selective engagement of the first and second dual-shaft electric motors and the first and second module clutches when the module is inserted into one or both of the first and second vertical apertures and is engaged with one or both of the first and second module gears; and
maintain the personal mobility/utility system in an upright position.

2. The personal mobility/utility system of claim 1, further including:
at least one primary battery disposed within the housing and configured for providing electrical power to the first and second dual-shaft electric motors, the sensor array and the controller.

3. The personal mobility/utility system of claim 1, wherein:
the motive inputs include one or more of a push exerted upon the personal mobility/utility system by the user, a pull exerted upon the personal mobility/utility system by the user and a turn exerted upon the personal mobility/utility system by the user;
the command inputs include one or more of a voice command, a button press, a button release, a joystick manipulation, a joystick release, a knob turn, a toggle manipulation, a selector manipulation, a slider manipulation, a caliper squeeze and a caliper release;
the environmental inputs include one or more of a proximity input indicative of a bearing, a proximity and/or an external location of an object, an obstacle or a geofence border within the surrounding environment, a geo-spatial positioning signal for determining a current location of the personal mobility/utility system, a warning from a warning device, and a navigation command or instruction from a navigation device; and
the attitude inputs include one or both of a forward degree of pitch of the personal mobility/utility system and a rearward degree of pitch of the personal mobility/utility system.

4. The personal mobility/utility system of claim 1, wherein the controller is further configured for one or more of:
determining a current location of the personal mobility/utility system;
determining one or more of a bearing, a proximity and an external location of an object, an obstacle or a geofence border within the surrounding environment;
causing the personal mobility/utility system to identify, avoid, approach and/or interact with the object, the obstacle or the geofence border; and
causing the personal mobility/utility system to follow and/or deviate from a predetermined path.

5. The personal mobility/utility system of claim 1, further comprising:
a walker module having an upright portion with a top end and a bottom end with the bottom end being configured for insertion into the first and second vertical apertures, and handlebars attached to the top end of the upright portion.

6. The personal mobility/utility system of claim 1, further comprising:
an outrigger module having a vertical portion with an upper end and a lower end with the lower end being configured for insertion into one of the first and second vertical apertures, an arm portion with a leading end attached to the upper end of the vertical portion and a trailing end opposite the leading end, and a caster attached to the trailing end of the arm portion.

7. The personal mobility/utility system of claim 6, wherein the upper end of the vertical portion has a vertically oriented socket formed therein, and further comprising:
a walker module having an upright portion with a top end and a bottom end with the bottom end being configured for insertion into the socket, and handlebars attached to the top end of the upright portion.

8. The personal mobility/utility system of claim 6, wherein the upper end of the vertical portion has a vertically oriented socket formed therein, and further comprising:
a cargo module having an upright portion with a top end and a bottom end with the bottom end being configured for insertion into the socket, a basket with a front side, a back side, a top side and a bottom side with at least one of the front and bottom sides being attached to the top end of the upright portion, and handlebars attached to at least one of the top and back sides of the basket.

9. The personal mobility/utility system of claim 6, wherein the upper end of the vertical portion has a vertically oriented socket formed therein, and further comprising:
a seat module having an upright portion with a top end and a bottom end with the bottom end being configured for insertion into the socket, and a seat attached to the top end of the upright portion.

10. The personal mobility/utility system of claim 6, wherein each of the first and second traction wheels includes a respective externally toothed portion sandwiched between a respective inner tire portion and a respective outer tire portion, and further comprising:
a wheel module having a rim, a tire attached to an outer circumferential surface of the rim, and a handrim attached to an outer face of the rim, the rim having an internally toothed portion sandwiched between a first inner circumferential surface and a second inner circumferential surface, an outer wall extending radially inward from the outer face and an inner wall extending radially inward from an inner face of the rim;
wherein one of the first and second traction wheels may be disposed in contact with the wheel module such that the respective externally toothed portion engages with the internally toothed portion, the respective inner tire portion is disposed in contact with the first inner circumferential surface between the internally toothed portion and the inner wall, and the respective outer tire portion is disposed in contact with the second inner circumferential surface between the internally toothed portion and the outer wall.

11. The personal mobility/utility system of claim 10, wherein the upper end of the vertical portion has a vertically oriented socket formed therein, and further comprising:
a seat module having an upright portion with a top end and a bottom end with the bottom end being configured for insertion into the socket, and a seat attached to the top end of the upright portion.

12. The personal mobility/utility system of claim 6, wherein each of the first and second traction wheels includes a respective tire portion and a respective externally toothed portion on a respective inner side and/or on a respective outer side of the respective traction wheel.

13. The personal mobility/utility system of claim 12, further comprising:
a wheel module having a rim, a tire attached to an outer circumferential surface of the rim, and a handrim attached to an outer face of the rim, the rim having an internally toothed portion adjacent and inside an inner wall extending radially inward from an inner face of the rim and/or adjacent and inside an outer wall extending radially inward from the outer face of the rim, and an inner circumferential surface between the inner wall and the outer wall;
wherein one of the first and second traction wheels may be disposed in contact with the wheel module such that the respective externally toothed portion engages with the internally toothed portion and the respective tire portion is disposed in contact with the inner circumferential surface between the inner wall and the outer wall.

14. The personal mobility/utility system of claim 1, wherein the personal mobility/utility system is separable into a first half which includes the first dual-shaft electric motor, the first traction wheel, the first module gear and the first generally tubular vertical aperture, and a second half which includes the second dual-shaft electric motor, the second traction wheel, the second module gear and the second generally tubular vertical aperture, and further comprising:
one or more telescoping rails each having a respective first rail end captured within the first half and a respective second rail end captured within the second half, wherein each of the one or more telescoping rails is configured for extending so as to dispose the first and second halves spaced apart from each other and for retracting so as to dispose the first and second halves in contact with each other.

15. The personal mobility/utility system of claim 14, further comprising:
an auxiliary battery configured for installation between the first and second halves when the first and second halves are spaced apart from each other.

16. The personal mobility/utility system of claim 15, wherein the auxiliary battery includes a radial slot therein defined by opposed slot walls, such that when the auxiliary battery is installed between the first and second halves, the one or more telescoping rails fit within the radial slot.

17. The personal mobility/utility system of claim 16, wherein at least one of the opposed slot walls includes a cooling inlet and at least one of the first and second halves includes a cooling port for supplying cooled air to the cooling inlet when the auxiliary battery is installed between the first and second halves.

18. The personal mobility/utility system of claim 2, further comprising:
an auxiliary battery port externally accessible through the housing and directly or indirectly electrically connected with one or more of the at least one primary battery and the first and second dual-shaft electric motors; and
an auxiliary battery configured for electrical connection with the auxiliary battery port.

19. A personal mobility/utility system, comprising:
a generally elongate housing having a center, a longitudinal axis passing through the center, and a midline passing through the center and running perpendicular to the longitudinal axis and defining opposed first and second ends of the housing;
first and second dual-shaft electric motors disposed within the housing at the first and second ends, respectively, with each having a respective inboard shaft extending toward the midline and a respective outboard shaft extending opposite the respective inboard shaft, wherein the respective inboard and outboard shafts are aligned parallel or colinear with the longitudinal axis;
first and second traction wheels rotatably attached to the first and second output shafts, respectively, via respective first and second wheel clutches and extending outside the housing at the first and second ends, respectively;
first and second module gears rotatably attached to the first and second inboard shafts, respectively, via respective first and second module clutches;
first and second generally tubular vertical apertures formed in the housing and having respective first and second top openings defined at a top of the housing and respective first and second bottom openings opposite the respective first and second top openings and situated adjacent the first and second module gears, respectively;
a sensor array disposed on or within the housing for detecting inputs including one or more of motive inputs from a user, command inputs from the user, environmental inputs from a surrounding environment and attitude inputs from an attitude sensor, and for providing one or more sensor signals indicative of the detected inputs;
a controller disposed within the housing for receiving the one or more sensor signals and for controlling the first and second dual-shaft electric motors, the first and second wheel clutches and the first and second module clutches so as to (i) provide propulsion, steering and braking of the personal mobility/utility system by selective engagement of the first and second dual-shaft electric motors and the first and second wheel clutches, provide one or more of extension, retraction and rotation of a module by selective engagement of the first and second dual-shaft electric motors and the first and second module clutches when the module is inserted into one or both of the first and second vertical apertures and is engaged with one or both of the first and second module gears, and maintain the personal mobility/utility system in an upright position;
at least one primary battery disposed within the housing and configured for providing electrical power to the first and second dual-shaft electric motors, the sensor array and the controller;
a first outrigger module having a first vertical portion with a first upper end and a first lower end with the first lower end being configured for insertion into the first vertical aperture, a first arm portion with a first leading end attached to the first upper end of the first vertical portion and a first trailing end opposite the first leading end, and a first caster attached to the first trailing end of the first arm portion; and
a second outrigger module having a second vertical portion with a second upper end and a second lower end with the second lower end being configured for insertion into the second vertical aperture, a second arm portion with a second leading end attached to the second upper end of the second vertical portion and a second trailing end opposite the second leading end, and a second caster attached to the second trailing end of the second arm portion.

20. A method for maneuvering a personal mobility/utility system having a center, a longitudinal axis passing through the center and defining a first side and a second side, a midline passing through the center and running perpendicular to the longitudinal axis, a first outrigger module attached to a top of the personal mobility/utility system at a first pivot point, and a second outrigger module attached to the top at a second pivot point, wherein the personal mobility/utility system is configured to carry a payload having a payload center of gravity, the method comprising:
positioning the personal mobility/utility system in a first position, wherein the payload center of gravity is located on the first side and the first and second outrigger modules are disposed on the first side;
rotating the first outrigger module about the first pivot point and toward the midline;
rotating the second outrigger module about the second pivot point and onto the second side;
repositioning the payload so as to move the payload center or gravity from the first side to the second side; and
rotating the first outrigger module about the first pivot point from the first side to the second side.
